(19) United States
(12) Patent Application Publication
(10) Pub. No.: US 2018/0018601 A1
(43) Pub. Date: Jan. 18, 2018

(54) EATING ESTABLISHMENT DESIGNED TO REDUCE WASTE AND IMPROVE CUSTOMER SATISFACTIN AND PROCESSES RELATED THERETO

(71) Applicant: Brian Wansink, Ithaca, NY (US)

(72) Inventor: Brian Wansink, Ithaca, NY (US)

(21) Appl. No.: 15/651,906

(22) Filed: Jul. 17, 2017

Related U.S. Application Data
(60) Provisional application No. 62/362,871, filed on Jul. 15, 2016.

(51) Int. Cl. G06Q 10/06; G01G 19/414; G06Q 30/02; G06Q 50/12

(52) U.S. Cl. CPC G06Q 10/0635; G06Q 50/12; G01G 19/4144; G06Q 10/0637; G06Q 30/0203

(57) ABSTRACT

An eating establishment is designed to reduce waste and increase satisfaction, providing: (a) sections and/or components that establish waste standards for determining food waste, (b) sections and/or components that establish satisfaction standards for determining customer satisfaction, (c) sections and/or components that analyze waste patterns based on the waste standards, and (d) sections and/or components that analyze customer satisfaction based on the satisfaction standards. In addition, the eating establishment might include (e) sections and/or components that develop a plan based on the analysis of waste patterns and customer satisfaction and (f) sections and/or components that implement the plan in one or more locations.

Methods or processes are provided for eating establishments to reduce waste and increase satisfaction, comprising: (a) establishing waste standards for determining food waste, (b) establishing satisfaction standards for determining customer satisfaction, (c) analyzing waste patterns based on the waste standards, and (d) analyzing customer satisfaction based on the satisfaction standards. In addition, the processes might include (e) developing a plan based on the analysis of waste patterns and customer satisfaction and (f) implementing the plan in one or more locations.

### CROSS-REFERENCE TO RELATED APPLICATIONS

A claim for priority to the Jul. 15, 2016 filing date of U.S. Provisional Patent Application No. 62/362,871, titled CAFETERIA AND RESTAURANT PROCESSES TO REDUCE WASTE AND IMPROVE CUSTOMER SATISFACTION (“the '871 Provisional Application”) is hereby made pursuant to 35 U.S.C. §119(e). The entire disclosure of each of the '871 Provisional Application is hereby incorporated herein.

### TECHNICAL FIELD

This disclosure relates generally to an eating establishment for reducing waste and improving customer satisfaction and processes related thereto. More particularly, this disclosure relates to an eating establishment, such as a cafeteria and restaurant, designed for reducing waste and increasing consumer satisfaction and healthy choices of food consumption and to processes involved therewith.

### BACKGROUND OF RELATED ART

In restaurants, cafeterias, buffets, and other commercial food service enterprises, vast amounts of food may be wasted daily. Much of this wasted food could be avoided by using better processes for evaluating the amounts of food wasted, how food is wasted, how customer satisfaction affects such waste and how consumers can be directed toward making healthy choices in food consumption.

Determining the amount of food wasted in such commercial enterprises has been a difficult task. One accurate method is to actually weigh the wasted food, but it requires considerable space, time and labor. Survey methods may be considerably faster but not as reliable for several reasons, including reporting biases. Visual processes for measuring food waste, such as the quarter-waste method, have had limited success in reliability and accuracy. See Hanks, et al., “Reliability and Accuracy of Real-time Visualization Techniques for Measuring School Cafeteria Tray Waste,” Journal of the Academy of Nutrition and Dietetics (2013).

Another approach to reducing waste is to promote customer satisfaction in food served. This focus is particularly relevant in restaurants, where it has been found that high-margin healthy foods can be promoted on the menus using psychological strategies, such as (1) shifting attention to certain foods, (2) enhancing taste expectations with pictures and descriptive terms, and (3) increasing perception of value by various menu devices.

Customer satisfaction has been measured by laddering interviews with customers of food establishments to uncover hidden insights into customer satisfaction that may not initially be apparent. See “Using Laddering to Understand and Leverage a Brand's Equity,” Quality Market Research, 6:2, 111-118, Wansink (2003). Another method has been used to prototype consumers based on how likely they may be to be wasteful and dissatisfied with the dining experience. This approach is useful in creating different solutions for different segments of diners. See Wansink, Brian, “Developing and Validating Useful Consumer Prototypes,” Journal of Targeting, Measurement and Analysis for Marketing, 3:1 18-30 (1994).

Despite this research and analysis, there remains the need to develop better eating establishments, as well as methods and systems to reduce and minimize waste and to increase consumer satisfaction and healthy choices of food consumption.

### SUMMARY

This disclosure might include an eating establishment designed to reduce waste and increase satisfaction, comprising: (a) sections and/or components that establish waste standards for determining food waste, (b) sections and/or components that establish satisfaction standards for determining customer satisfaction, (c) sections and/or components that analyze waste patterns based on the waste standards, and (d) sections and/or components that analyze customer satisfaction based on the satisfaction standards. In addition, optionally, the eating establishment might include (e) sections and/or components that develop a plan based on the analysis of waste patterns and customer satisfaction and (f) sections and/or components that implement the plan in one or more locations.

This disclosure might further include methods for eating establishments to reduce waste and increase satisfaction, comprising: (a) establishing waste standards for determining food waste, (b) establishing satisfaction standards for determining customer satisfaction, (c) analyzing waste patterns based on the waste standards, and (d) analyzing customer satisfaction based on the satisfaction standards. In addition, optionally, the processes might include (e) developing a plan based on the analysis of waste patterns and customer satisfaction and (f) implementing the plan in one or more locations.

### BRIEF DESCRIPTION OF THE DRAWINGS

In the drawings:

FIG. 1 is an overall schematic diagram of an embodiment of an eating establishment according to the present disclosure;

FIG. 2 is a schematic diagram of stage A of the diagram shown in FIG. 1;

FIGS. 3A and 3B are schematic diagrams of stage B of the diagram shown in FIG. 1;

FIG. 4 is a schematic diagram of stage C of the diagram shown in FIG. 1;

FIG. 5 is a schematic diagram of stage D of the diagram shown in FIG. 1; and

FIG. 6 is a schematic diagram of stage E of the diagram shown in FIG. 1;

FIG. 7 is an overall schematic diagram of an embodiment of methods and processes for analyzing and improving an eating establishment according to the present disclosure;

FIG. 8 is a schematic diagram of stage A of the diagram shown in FIG. 7;

FIGS. 9A and 9B are schematic diagrams of stage B of the diagram shown in FIG. 7;

FIG. 10 is a schematic diagram of stage C of the diagram shown in FIG. 7;

FIG. 11 is a schematic diagram of stage D of the diagram shown in FIG. 7;

FIG. 12 is a schematic diagram of stage E of the diagram shown in FIG. 7; and

FIG. 13 is an embodiment of a behavior event modeling map that identifies a variety of possible events and/or other factors that might lead an individual to eat food from a particular eating establishment.

### DETAILED DESCRIPTION

Part One: Eating Establishment Designed to Reduce Waste and Increase Customer Satisfaction

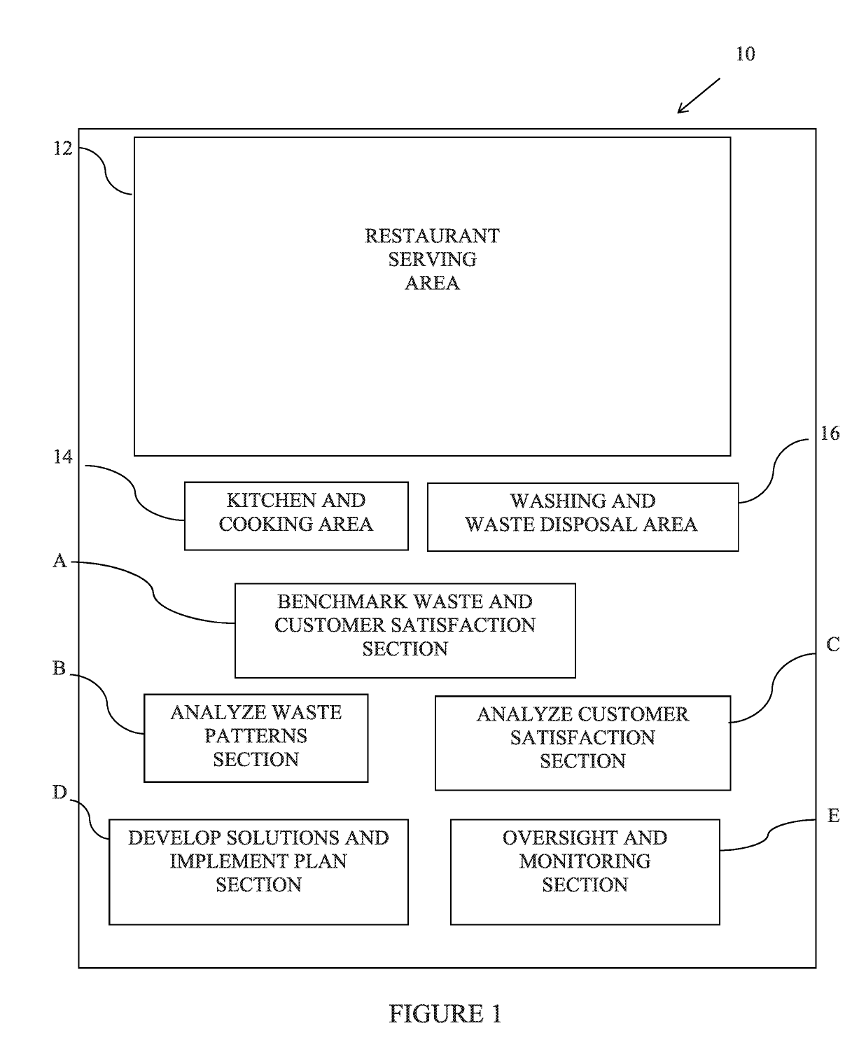

Looking first at FIG. 1, an eating establishment 10, such as a cafeteria or restaurant, being designed to reduce waste and increase customer satisfaction, according to the embodiments of the disclosure. Eating establishment 10 includes a restaurant dining area 12 for customers to be served and consume food. In this embodiment, the dining area 12 may be a conventional area, typically having tables and chairs to accommodate diners.

Next to the dining area 12 is a kitchen and food preparation area 14 which may also be a conventional area with cooking and food storage appliances and working spaces and equipment for preparing food. Also adjacent to the dining area is washing and waste disposal area 16. Area 16 may also be a conventional area having machines for washing and drying dinnerware and containers for the disposal food waste.

The remaining sections in the eating establishment 10 in these embodiments are not conventional. Rather, they are included in these eating establishment embodiments to provide benchmarks for waste considerations and for determining customer satisfaction. Components are provided to analyze food waste and customer satisfaction in comparison to the above benchmarks and standards in order to develop plans and solutions for improving the operation of the eating establishment. These current embodiments provide positive results of reducing food waste while improving customer satisfaction. Accordingly, the present embodiments assist an owner in more economically operating an eating establishment while improving customer relationships and drawing new customers to the eating establishment.

The current embodiments include components and/or sections to establish waste and satisfaction benchmark standards, components and/or sections to analyze food waste patterns, components and/or sections to analyze customer satisfaction and components and/or sections to develop solutions and implement plan solutions and to provide oversight and monitoring with respect to the eating establishment.

Continuing to reference FIG. 1, stage A provides components that develop benchmark standards regarding food waste and regarding customer satisfaction. At stage B, a section is provided with components to analyze food waste in view of these benchmarks. At stage C, a section is provided with components to analyze customer satisfaction in view of these benchmarks. At stage D, a section is provided with components to develop an improved plan based on the results of this analysis and to implement the improved plan in the eating establishment of the present disclosure. At stage E, a section is provided with components to provide oversight and monitoring of the improved eating establishment.

It should be understood that the sections for these stages A-E do not need to be utilized in the order given herein. Each separate section corresponding to its stage may be implemented independent of the other stages.

As will be discussed below, benchmarking sections may be used to determine standards for waste, including units that measure food waste according to weight, size, feel and/or appearance. Benchmarking sections are also used to determine customer satisfaction include new survey techniques that focus on future revenue. Section components also provide waste analysis using inside source surveys, modeling and story-telling techniques. Waste analysis sections may also determine patterns with respect to prepared food waste and plate waste. A section may also be provided to determine customer-based analysis of customer satisfaction, and to assist in implementing improved plans.

Stage A—Section and/or Components for Benchmarking of Waste and Customer Satisfaction

Benchmarking Food Waste:

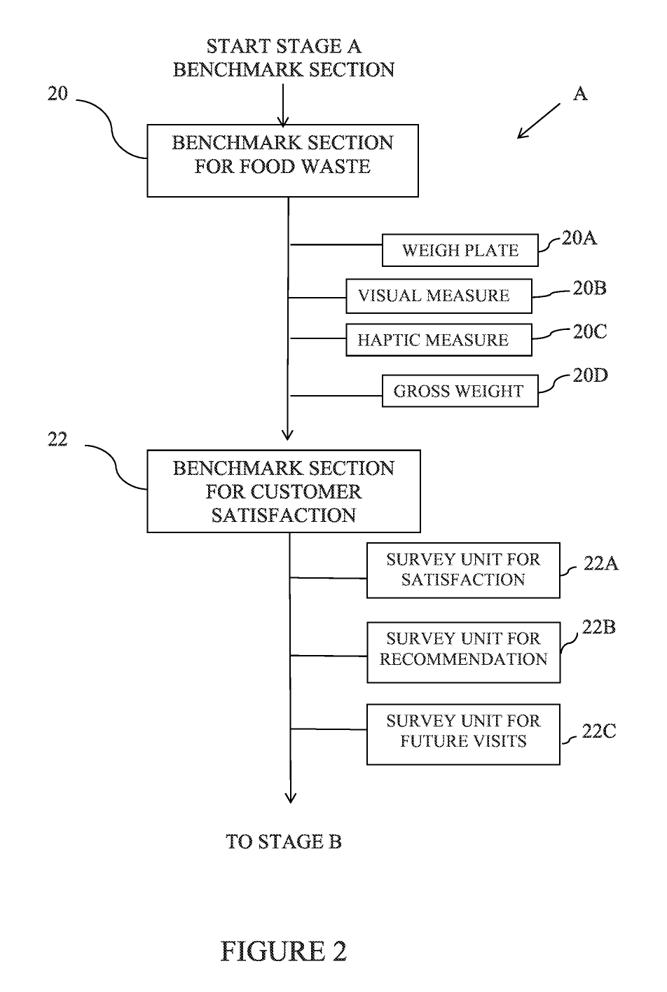

Looking next at FIG. 2, the benchmarking stage A of the above system 10 is shown in more detail. At 20, a benchmark section is provided for food waste. Computer processing may be used to review representative stratified samples of units (in the case of restaurant, cafeteria, or buffet chains with multiple units). Initially, existing purchase records and waste records may be reviewed by computer processing (indexed by the number of diners during that time period). Then the amount of food waste may be determined (e.g., two or more weekdays) for targeted items by measuring individual plate waste. The following are several different approaches used with various components to measure food waste. They are approaches that may be used separately or in combination to determine food waste.

At 20A, a traditional weighing approach is taken, in which each plate or tray is weighed by conventional weighing components when full and again when an individual has finished eating. Although this approach is very accurate, it is also very time-consuming and inefficient.

At 20B, food waste may be determined by using the quarter-waste method or quarter-plate method, discussed in Hanks, et al., “Reliability and Accuracy of Real-time Visualization Techniques,” Journal of the Academy of Nutrition and Dietetics (2014). In the quarter-waste method, a food worker may visually estimates the amount of each food item left on a tray or plate—none, ¼, ½, ¾, or all. A camera may be used for preparing and making the visual estimates. This approach is more efficient, but less accurate than the weighing approach.

At 20C, a new haptic (touch) approach is used, which is particularly helpful with an enclosed product, such as milk or yogurt. A food worker may pick up a container holding waste food and estimate by touch the weight of the food remaining in terms of the quarter-waste method, that is none, ¼, ½, ¾, or all. Alternately, the container may be sensed by conventional sensing devices or weighed and/or photographed by a food worker on conventional scales or photographed to compare with the worker's estimate by touch, in order to determine an accurate estimate of each container feels with amounts of food left in the container.

At 20D, a new gross weight system is used. The gross weight of food served in a cafeteria or restaurant is measured by conventional scales prior to an event, such as at a daily opening. Then the net weight of served food remaining in a cafeteria or restaurant is measured after an event, such as at the time of closing. The difference in the gross and net weights is divided by the number of guests during the day to give an average amount of food consumed during the day per guest. The net weight is divided by the number of guests during the day to provide an average amount of food wasted per day per guest.

Benchmarking Customer Satisfaction:

At 22, benchmarking of customer satisfaction may be determined by computer processing of various surveys. Customer satisfaction data from representative stratified samples of units may be processed by computer. At step 22A, data regarding customer satisfaction benchmarking may be processed using existing measures, such as survey questions asking each customer to grade his or her satisfaction on a scale.

Alternately, a new type of survey may be computer processed wherein less direct survey questions may be used. At 22B, customers may be asked how likely they may be to recommend an eating establishment to a visitor. Interestingly, this approach helps the surveyed customer eliminate the subjective aspects and become more objective. The survey is no longer directly about the surveyed customer, it is concerned with whether a third person would be given a recommendation to visit the establishment.

Another new type of survey has been shown to be effective in determining the lifetime or future value of the cafeteria or restaurant. At step 22C, a customer survey may processed that focuses on questions such as, “The next ten times you visit this area, how many times would you eat here?” Or, “How many people would you eat with at this establishment in the future?” Or, “If certain changes were made, would you be more likely to eat here?” This survey approach works particularly well in determining whether certain changes should be made to ensure future business. Other similar questions may be asked in a future oriented manner to assess repeat patronage, restaurant quality, satisfaction, healthy eating perceptions, waste perceptions, value and the like.

Stage B—Waste Analysis and Reduction

Analysis of Food Waste:

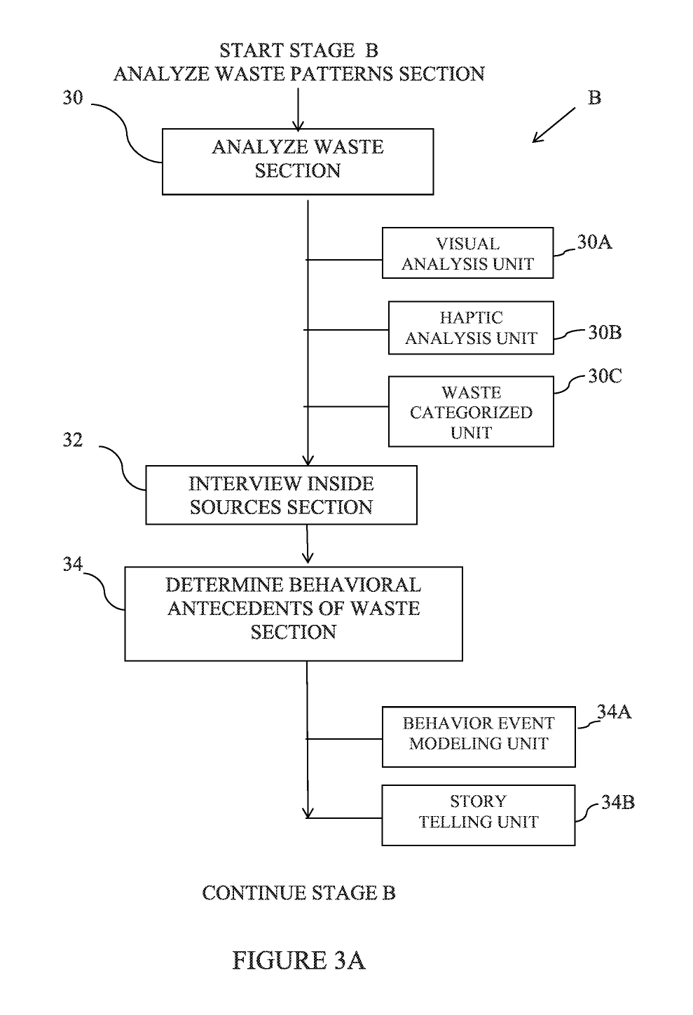

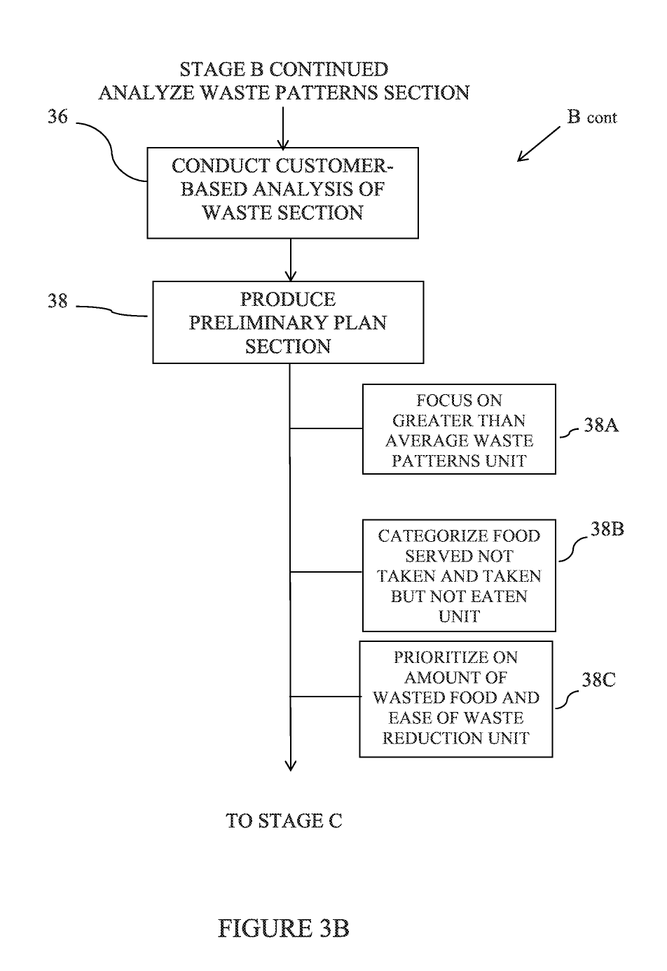

Looking now at FIG. 3A, after determining benchmarks for food waste and customer satisfaction, components are provided at 30 in stage B for analyzing patterns and processes of both food waste and customer satisfaction, in order to determine how to minimize food waste and how to maximize customer satisfaction.

At 30A, in representative cafeterias and restaurants, two types of waste measurements may be taken regarding: (a) food that is prepared but which diners take (e.g., do not elect to serve to themselves), referred to as “prepared food waste,” and (b) food that diners take (e.g., serve to themselves) but do not eat, called “plate waste.” Traditional processes, such as using scales for weighing or using cameras for visual assessment, may be made to determine or quantify prepared food waste and/or plate waste.

At 30B, haptic processes may be used to estimate waste in enclosed or partially enclosed containers, in terms of whether the waste is none, ¼, ½, ¾, or all. This haptic approach is similar to the above Benchmarking step 20C. A food worker is taught by touch how heavy each container feels with each of the above amounts of food left in the container. Alternately, conventional sensing equipment may be utilized, or photographs may be taken by camera to assist the food worker with this method.

At 30C, an analytic method using computer processing may be used to categorize foods by the overall cost of their waste (not costly vs. costly) and by how easy it would be to reduce their waste (easy vs. not easy).

At 32, a new interviewing technique may be analyzed using computer processing of data derive from the inside source interviews of certain employees to determine process-related issues resulting in food waste and perceptions of diner behavior patterns. In this method, key interviews may be taken with “inside sources,” that is, workers who either frequently or intensively interact with the target market in a service-related context. Data from these inside sources may be computer processed to determine the results of these interviews.

Examples of inside sources may be purchasers of high-end electronics, soft drink consumers, power tool buyers, energy drink enthusiasts, and new car shoppers. They can also include personal assistants, charter flight pilots, chief operating officers, tailors, accountants, attorneys, car dealers, and chauffeurs. Inside sources may be embedded in repeated situations, giving them tacit understanding of subtle behavior patterns that might go unnoticed by trained observers. By repeated similar experiences, inside sources might develop customer typologies or prototypes, see tendencies in impulse buying patterns or predict critical incidents that might alienate shoppers, even before an incident happens.

In a marketing context, for example, inside sources may be consumers who buy one brand versus another brand or consumers who may be price sensitive or insensitive in a particular category. In a public health context, as another example, they can include people who exhibit a certain type of behavior, such as people who eat vegetables at every meal, people who recycle, parents who have healthy weight children, and those who drink more milk than soft drinks.

Inside source interviews can impressively uncover unique insights that might otherwise be overlooked. The process usually involves choosing a research objective, selecting appropriate inside sources, determining specific questions that will elicit meaningful responses, and translating the responses into tangible actions within the marketing mix.

Insights from inside sources can be quantified by follow-up surveys and can be verified by experiments to improve marketing efforts. However, using inside sources has some limitations. Inside source responses can lack objectivity and may generate idiosyncratic insights that may be difficult to generalize. An advantage to the inside source approach is that it need not be limited to marketing. It can also be used to illuminate social concerns, such as healthy eating, active lifestyles and financial well-being.

Summarizing, inside source interviews concerned with the analysis of waste in cafeteria and restaurant food services might quickly and effectively provide unique and valuable insights that could be missed in costly laddering interviews, series of focus groups, and wide-scale surveys.

Referring to 34 in FIG. 3A, waste patterns may be determined by computer processing of data derived in connection with behavioral antecedents of waste.

At 34A behavioral event modeling is utilized, and at step 34B a story telling method is used to determine antecedents of waste and possible solutions.

Looking at 34A, using computer processing and/or modeling, the main objective of behavior event modeling (“BEM”) is to determine possible sequences of events that would lead to a target outcome or “critical incident.” Data related to these sequences are processed to critically identify all of the various antecedent events that could possibly influence the target outcome or incident, as well as any indicators (signals) along the way. BEM data is derived from a predictive computer model of behavior by beginning with a critical event and then working backwards to identify different sequences of events that could lead up to the critical event, as well as the data regarding indicators that are associated with each event in a sequence.

Accordingly, with BEM, the end outcome is the starting point rather than the final step. The advantage of this approach is that it allows for the development of a more diverse range of possible pathways that may lead up to a critical event, rather than having to begin the analysis with a given behavior having subsequent possibilities that may be more limited. Additionally, the BEM approach to predictive computer modeling is distinct in that it examines a sequence of events in its entirety and draws on past events as influencers of a specific behavior or critical incident.

BEM has advantages over conventional methods, such as focus groups or questionnaires. Consumers may not be able to determine or be able to articulate their subconscious decisions that may lead to a conclusion. Moreover, demographic and psychographic data can be extremely costly to obtain and may be skewed because of subjectivity. Analyzing BEM data is relatively quick and inexpensive using computer processing and modeling and tends to be quite objective. It is also easily accessable, since all that is required is an imaginative mindset. It can also elicit insights without any other individuals actually present.

Thus, with BEM, one is concerned primarily with sequences of events leading to a critical incident, as well as indicators, insights and interventions that may arise.

Referring now to 34B, the Story Telling approach may also be utilized in analyzing waste patterns. A story-telling approach may be used to determine the reasons consumers engage in low-consciousness decision making, which is done almost automatically.

In the story-telling method of insight generation, researchers input computer data derived from direct behavior observations of a consumer to stimulate insights on motivations for their actions and on influential variables in their environment. The story-telling approach is important in identifying the reasons for low-involvement behavior which become the subconscious rationale behind consumer decision making. Data from each story telling may be computer processed to develop computer models that determine correlation in each story telling incident. Computer processing this data provides a low-cost, simple way to develop insights that may lead to changes in an establishment. By telling the story about another person, a researcher is freed from inhibitory reactions during observational situations.

In the story-telling method, researchers generate insights rooted in observation of actions. The researcher usually sets the scene for a consumer with a general description of the appearance and socioeconomic status of a hypothetical individual, and a narrative describing objective events and behavior that has occurred with the individual. With this background, a consumer is requested to tell a story about how the individual reacts to his surroundings and activities, and describe actions that the individual is likely to take. A researcher might start the story-telling by asking why the individual took the action described or found himself/herself in the event described. The individual will then make inferences about the situation to carry the story forward. Each step of imagined inferences builds upon the previous one, all rooted in each initial observed action. Such stories lend themselves to simple computer processing of related data from each story to determine useful results.

Customer Analysis of Waste and Satisfaction.

At 36 in FIG. 3B, customer analysis of waste and customer satisfaction is included. Data regarding self-reported descriptions of waste may be computer processed to assist in analyzing waste patterns. Analysis of data derived from customers regarding waste and satisfaction may both be determined through insights and computer modeling using data obtained through story-telling. Incidents influencing satisfaction and dissatisfaction may be assessed through in-person interviews and open-ended surveys. Satisfaction is likely to also be determined by the perceived purposes of the eating establishment. For example, a restaurant in a business-related hotel is likely to have a main purpose of providing quality food with little concern about flair. In contrast, a restaurant located in a tourist-related hotel is likely to focus on providing an adventure along with exciting foods.

Preliminary Plan for Waste Reduction.

At 38 in FIG. 3B, a preliminary plan is developed for waste reduction by computer processing various data from the following approaches. In 38A, the focus is on how preparation waste can be reduced by better managing and predicting customer demand. Data may be analyzed by computer processing and modeling regarding high waste areas, such as hot foods, meats, salads, breads, and desserts, where the waste patterns may be greater than average for a cafeteria in its particular industry. In 38B, the focus of computer processing and modeling is on how plate waste can be reduced by altering traffic patterns, food layout, portion sizing, selection norms, serving quantities, taste expectations, and the like. Having identified the specific target categories that may be most problematic and understanding initial possible reasons for the waste, the general categories of food may be prioritized at step 38B for action based on whether the problem comes from whether the food is served but not taken or whether it is taken but not eaten.

For each of these two categories, food items may be then prioritized in a computer model based on (a) amount of wasted food (in dollars) and (b) ease of waste reduction. High cost foods which can be easily reduced or eliminated to reduce or minimize waste will be prioritized for action over lower cost foods which may be more difficult to reduce or eliminate from the menu. The actual solutions for reducing the prioritized foods will be determined by the results of data derived from the above computer modeling, in which insights from inside source interviews, insights from behavioral event modeling and storytelling and customer process interviews are combined in one or more computer models.

One or more preliminary plans at 38 are provided as a result of the above computer processing and modeling to provide a set of actions which may be taken to partially remedy or reduce the problem with food waste and food costs within each category of food. What is important to understand, however, is that efforts at reducing food costs by reducing food waste can also reduce a diner's satisfaction toward a cafeteria or a restaurant. For instance, in an extreme case, having only a few food items in a small quantity would succeed in greatly reducing food costs, but it would also greatly reduce satisfaction because a person would not have a wide range of foods to sample and they would not have enough food to be full. Accordingly, the objective is to reduce food waste and food costs in a way that does not hurt a diner's satisfaction.

Stage C—Customer Satisfaction Analysis

Before final recommendations may be provided it is important to determine what foods can be eliminated from the cafeteria and which new foods, if any, should be introduced. Both of these may be driven by customer satisfaction. If customer satisfaction is a critical issue, it should be considered as the second phase of a cafeteria makeover.

Laddering Analysis of Cafeteria Champions.

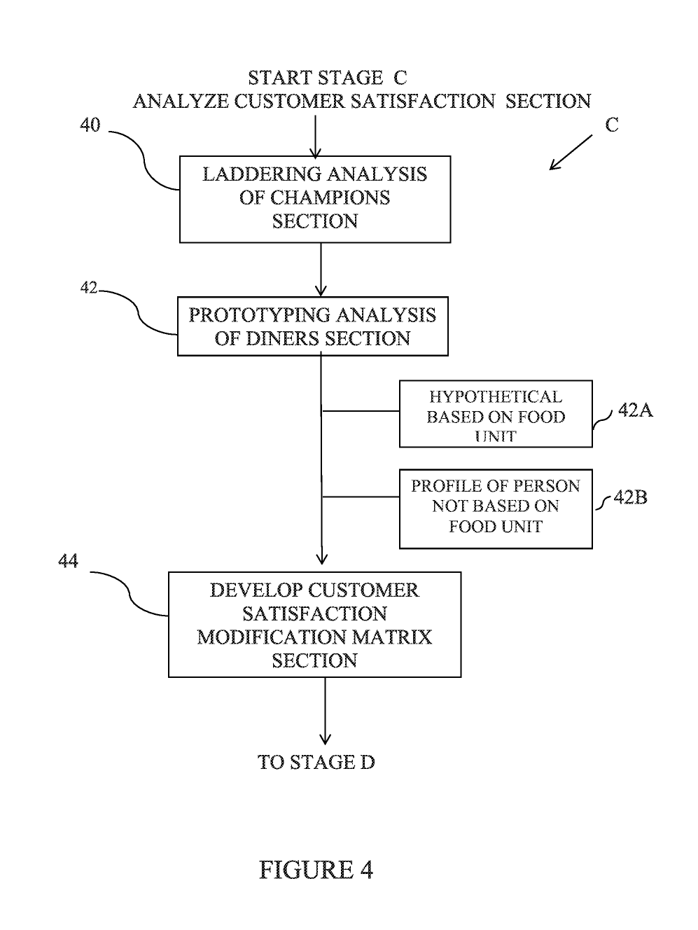

Looking now at 40 in FIG. 4, a new laddering analysis is made, using computer processing and/or computer modeling and focusing on cafeteria and restaurant champions. By identifying the most satisfied customers, laddering interviews may be conducted to determine the attributes they initially identify as sources of their heightened satisfaction, the resulting consequences of this satisfaction, and the higher related values. In known techniques of laddering interviews follow-up questions are asked to uncover deeper motivations for the values of the customer. Data from these interviews is used in computer processing and/or computer modeling to make the above analyses.

In this new approach, only major champions of a cafeteria or restaurant are chosen for interviews. These are customers who are enthusiastic, even fanatical, about the eating establishment, and would go out of his way to be able to return to it again and again. These champions may be asked several questions that all focus on the reasons that they are so enthusiastic about the eating place. The interviews may be conducted in person, by phone, or through the use of cards or surveys, although face-to-face interviews are preferred—in person, or via SKYPE® or phone.

Prototyping Analysis of Diners.

Diners may be prototyped based on how likely they are to be wasteful and dissatisfied. Known prototype analysis is used to create different solutions for three of the most critical segments of diners, using a prototyping methodology explained in Wansink, Brian, “The Customer Prototyping Technique: Its validation and Application,” Journal of Targeting, Measurement and Analysis for Marketing, p. 18 (Jul. 8, 1994), incorporated in full herein.

Mentally visualizing a prototypical member of a market segment is critically important. Customer prototyping may be done through laddering questions and procedures to describe a very specific hypothetical member of a target sub-segment of the marketplace. The assumption is that the insights obtained from describing and analyzing this particular individual may frequently be generalized across a broader segment. It is quick, inexpensive and easily interpretable.

A new prototyping process may be used, in which all questions have to do with a profile of a person, rather than focusing on a specific aspect, such as food. By outlining a complete profile of a customer, data is developed for using in the above-mentioned computer processing and/or computer modeling, so that solutions are more easily understood regarding the necessary features and aspects of an eating establishment under consideration.

Customer Satisfaction Modification Matrix.

Referring again to FIG. 4, based on the results of laddering interviews and prototypes of key customer prototypes, three sets of recommendations for food item eliminations, additions, and physical modifications to the cafeteria (including layout, messaging, and so forth) may be presented for each of the three segments. These recommendations may be based on the results of Section B regarding waste analysis and reduction. B Using this data in computer processing and computer modeling, a new customer satisfaction modification matrix is developed in quadrants showing how each of the potential recommendations the changes will influence be received by each of the three customer prototypes that may be most relevant to the success of the business. This quadrant matrix may take an initial form that is focused on features that vary in importance to customers versus features that vary in cost savings for a given amount of waste.

Stage D—Developing Solutions, Testing and Final Plan

Plan for Waste Reduction and Satisfaction Enhancement.

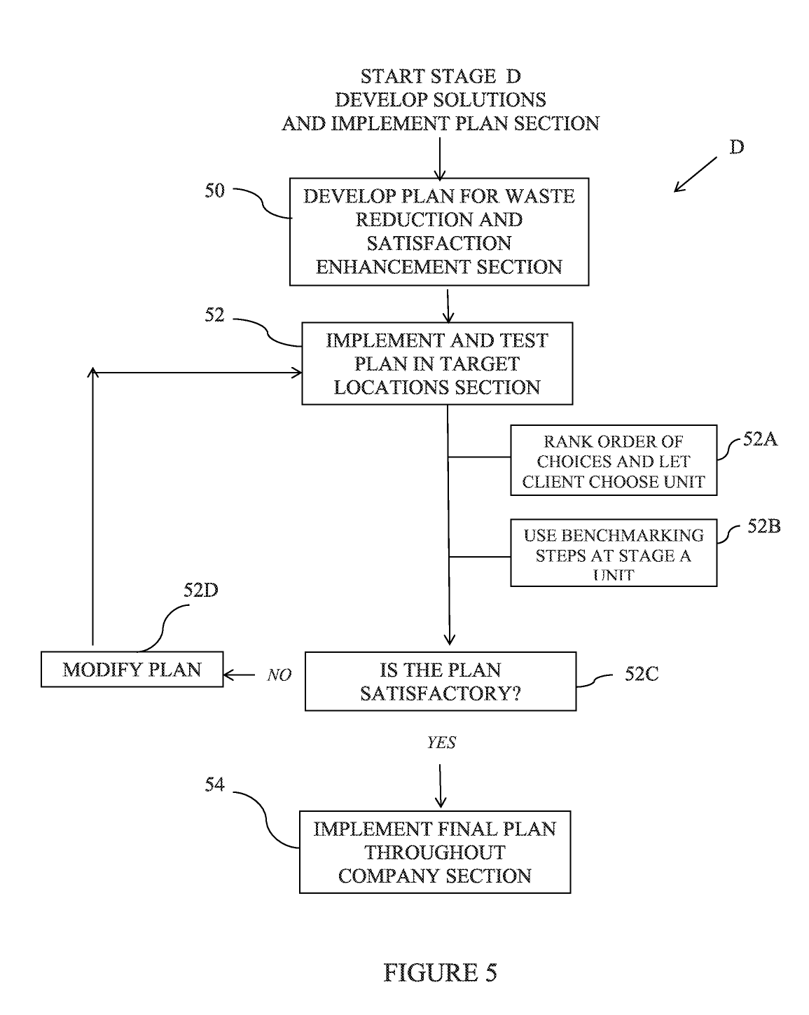

Looking now at FIG. 5, the preliminary waste reduction plan is integrated with the Customer Satisfaction Modification Matrix, using computer processing and/or computer modeling, to determine the priorities for change, based on what will reduce waste (food costs) and increase key satisfaction ratings for the least cost for the most important target segments.

Previously, the range of possible waste recommendations was determined to reduce the biggest potential waste problems. Data regarding these recommendations may be compared with data regarding the three primary prototypes of consumers to determine which of these recommendations has the least negative impact on these segments individually and in the aggregate. This computer processing and/or computer modeling results may provide the priority recommendations that may be proposed. One approach is to first rank an order of choices that may be desirable using key factors, such as cost savings and best improvement in satisfaction. Then a client would select the changes to implement.

Implementing and Testing the Proposed Plan in Initial Target Locations.

As shown in FIG. 5, the agreed upon plan is implemented for an agreed upon time period. The same measures of waste and satisfaction that were collected at the beginning of the project in benchmarking steps 20 and 22 may be now collected at this point and analyzed.

Based on modifications following the testing period one or more plans may be presented to management based on any variations between types of units, such as small versus large.

Stage E—Implementation Oversight and Cost/Satisfaction Monitoring

Revised Implementation Plan.

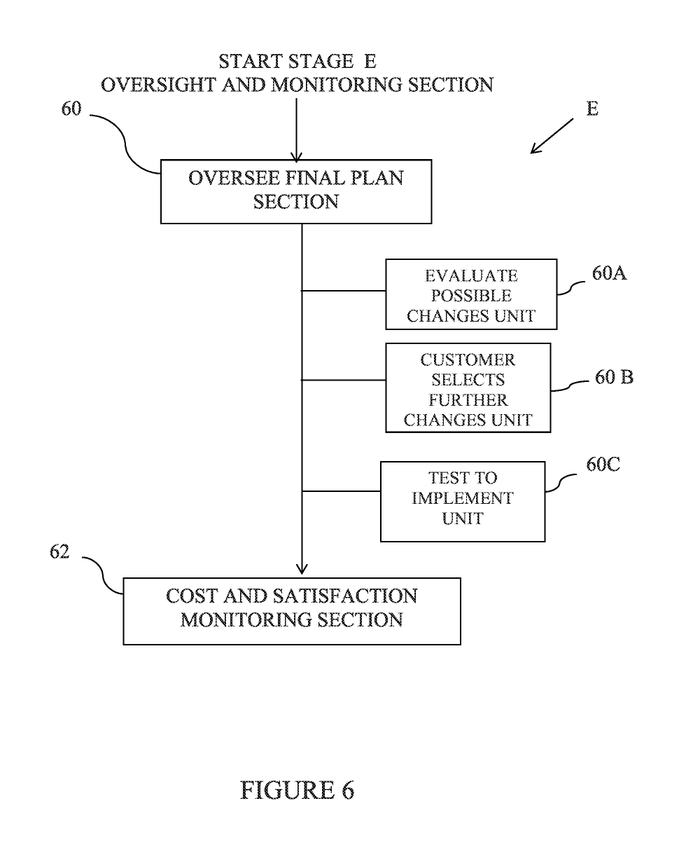

Referring now to FIG. 6, upon acceptance of the final plan, a separate engagement involves implementation across units. One key part of this implementation is the analysis of data derived from basic scorecards, using computer processing and/or computer modeling that enable operators of different units to determine what is most feasible for them. The development of these scorecards incorporates the actions identified in Steps 30-38. These scorecards consist of binary “yes/no” questions which enable an operator or an evaluator to generate computer data regarding how compliant a particular cafeteria is regarding making the changes that may be most associated with reduced food waste. This data is computer processed to provide computer reports and/or computer modeling necessary to implement and monitor the plan.

Consider a scorecard of 25 actions that were initially identified in Steps 30-38 and which was subsequently screened down to 17 actions in Step 10. This list of 17 actions (such as “desserts may be offered in ½ size portions”) can be answered by a layperson based on yes/no answers. A score of 17, in this example, would be a perfect score.

Part Two: Processes for Eating Establishment to Reduce Waste and Increase Customer Satisfaction

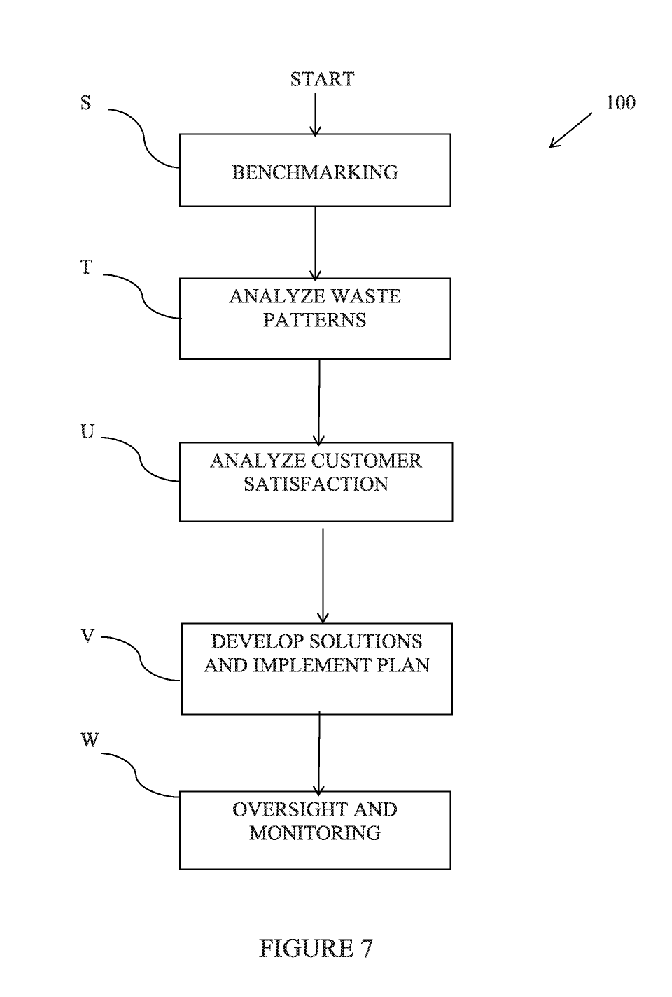

Referring now to at FIG. 7, a system 100 for providing new and useful methods to analyze food waste and customer satisfaction with respect to food services at cafeterias and restaurants is depicted. At stage S, benchmarks or criteria may be established for food waste and customer satisfaction. Then, at stage T, food waste is analyzed against these benchmarks, using new methods and processes. Next, at stage U, customer satisfaction is analyzed against these benchmarks, using new methods and processes. Then, at stage V, an improved plan is developed based on the results of this analysis. Finally, at stage W, the improved plan is implemented.

As will be discussed below, benchmarking processes for determining waste include haptic measurements and new weighing techniques. Benchmarking methods for determining customer satisfaction include new survey techniques that focus on future revenue. Waste analysis uses new inside source surveys, modeling and story-telling techniques. Waste patterns may be analyzed with respect to prepared food waste and plate waste. A new customer-based analysis of customer satisfaction is applied and a preliminary plan is prepared.

Stage S—Benchmarking of Waste and Customer Satisfaction

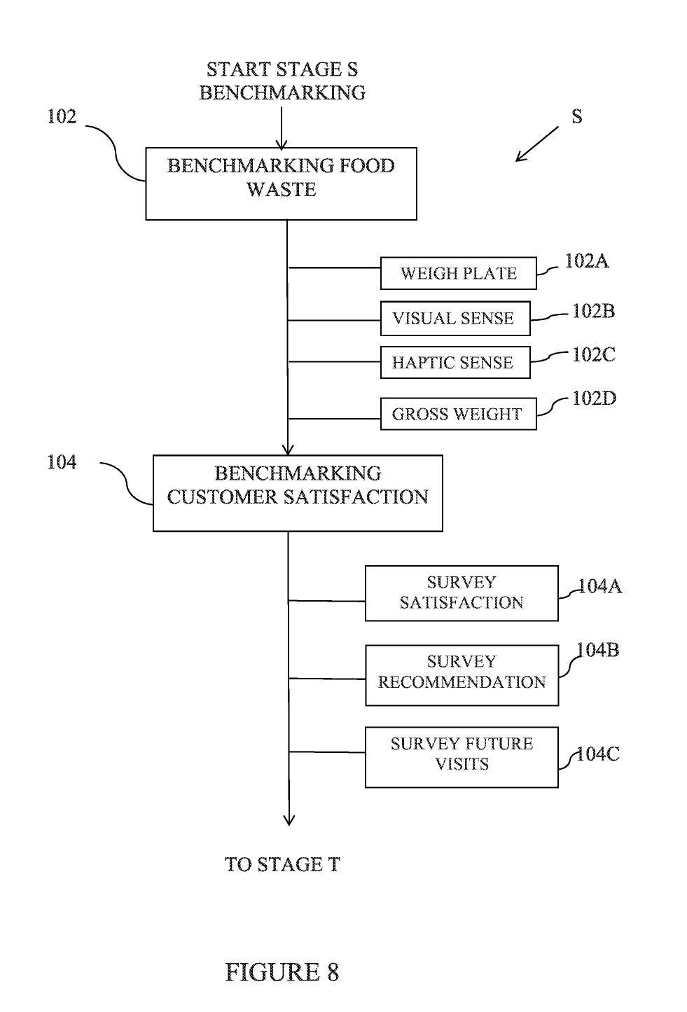

Looking next at FIG. 8, the benchmarking stage S of the above system 100 is shown in more detail. It should be understood that the steps recited herein do not need to be taken in the order given herein. Each separate step may be implemented independent of the other steps.

Benchmarking of Food Waste.

Step 102 is concerned with setting up benchmarks for food waste. Across a representative stratified sample of units (in the case of restaurant, cafeteria, or buffet chains with multiple units), a basic benchmarking of food waste is conducted. Initially, existing purchase records and waste records may be used (indexed by the number of diners during that time period). Then the amount of food waste may be determined (e.g., two or more weekdays) for targeted items by measuring individual plate waste.

At step 102A, a traditional weighing approach is taken, in which each plate or tray is weighed when full and again when an individual has finished eating. Although this approach is very accurate, it is also very time-consuming and inefficient.

At step 102B, food waste may be determined by using the quarter-waste method or quarter-plate method, discussed in Hanks, et al., “Reliability and Accuracy of Real-time Visualization Techniques,” Journal of the Academy of Nutrition and Dietetics (2014). In the quarter-waste method, a food worker visually estimates the amount of each food item left on a tray or plate—none, ¼, ½, ¾, or all. This approach is more efficient, but less accurate than the weighing approach.

At step 102C, a new haptic (touch) approach is used, which is particularly helpful with an enclosed product, such as milk or yogurt. The food worker picks up the container and estimates by touch the weight of the food remaining in terms of the quarter-waste method, that is none, ¼, ½, ¾, or all. A food worker is taught by touch how heavy each container feels with each of the above amounts of food left in the container.

At step 102D, a new gross weight system is used. The gross weight of food served in a cafeteria or restaurant is measured prior to an event, such as at a daily opening. Then the net weight of served food remaining in a cafeteria or restaurant is measured after an event, such as at the time of closing. The difference in the gross and net weights is divided by the number of guests during the day to give an average amount of food consumed during the day per guest. The net weight is divided by the number of guests during the day to provide an average amount of food wasted per day per guest.

Benchmarking Customer Satisfaction.

Step 104 in stage S involves developing benchmarking of customer satisfaction across the same representative stratified sample of units used in the food waste benchmarking. At step 104A, customer satisfaction benchmarking may be done using existing measures, such as survey questions asking each customer to grade his or her satisfaction on a scale. The approach has not been very effective because it is too subjective and open ended.

A new type of survey has been implemented wherein less direct survey questions may be used. At step 104B, customers may be asked how likely they may be to recommend an eating establishment to a visitor. Interestingly, this approach helps the surveyed customer eliminate the subjective aspects and become more objective. The survey is no longer directly about surveyed customers, it is concerned with whether third persons would be given a recommendation to visit the establishment.

Another new type of survey has been shown to be effective in determining the lifetime or future value of the cafeteria or restaurant. At step 104C, a customer survey may focus on questions such as, “The next ten times you visit this area, how many times would you eat here?” Or, “How many people would you eat with at this establishment in the future?” Or, “If certain changes were made, would you be more likely to eat here?” This survey approach works particularly well in determining whether certain changes should be made to ensure future business. Other similar questions may be asked in a future oriented manner to assess repeat patronage, restaurant quality, satisfaction, healthy eating perceptions, waste perceptions, value and the like.

Stage T—Waste Analysis and Reduction

Looking now at FIG. 110, after determining benchmarks for food waste and customer satisfaction, stage T involves analysis of patterns and processes of both food waste and customer satisfaction, in order to determine how to minimize food waste and how to maximize customer satisfaction.

Analysis of Waste Patterns.

At step 110A, in representative cafeterias and restaurants, it is known for two types of waste measurements to be taken: (a) food that is prepared but which diners take (e.g., do not elect to serve to themselves), referred to as “prepared food waste,” and (b) food that diners take (e.g., serve to themselves) but do not eat, called “plate waste.” Traditional processes, such as weighing or visual assessment, may be made to determine or quantify prepared food waste and/or plate waste.

At step 110B new haptic processes may be used to estimate waste in enclosed or partially enclosed containers, in terms of whether the waste is none, ¼, ½, ¾, or all. This haptic approach is similar to the above Benchmarking step 1c. A food worker is taught by touch how heavy each container feels with each of the above amounts of food left in the container.

At step 110C, a new analytic method may be used to categorize foods by the overall cost of their waste (not costly vs. costly) and by how easy it would be to reduce their waste (easy vs. not easy).

Interview Inside Sources to Determine Waste and Diner Behavior Patterns.

At step 112, a new interviewing technique is the process of using inside source interviews of certain employees to determine process-related issues resulting in food waste and perceptions of diner behavior patterns. In this method, key interviews may be taken with “inside sources,” that is, workers who either frequently or intensively interact with the target market in a service-related context. These front-line workers may be usually not credentialed or professionals.

Types of Inside Sources.

Examples of inside sources may be purchasers of high-end electronics, soft drink consumers, power tool buyers, energy drink enthusiasts, and new car shoppers. They can also include personal assistants, charter flight pilots, chief operating officers, tailors, accountants, attorneys, car dealers, and chauffeurs. Inside sources may be embedded in repeated situations, giving them tacit understanding of subtle behavior patterns that might go unnoticed by trained observers. By repeated similar experiences, inside sources might develop customer typologies or prototypes, see tendencies in impulse buying patterns or predict critical incidents that might alienate shoppers, even before an incident happens.

In a marketing context, for example, they might be consumers who buy one brand versus another brand or consumers who may be price sensitive or insensitive in a particular category. In a public health context, as another example, they can include people who exhibit a certain type of behavior, such as people who eat vegetables at every meal, people who recycle, parents who have healthy weight children, and those who drink more milk than soft drinks.

Reference is made to TABLE 1, with specific illustrations of identifying possible inside sources.

TABLE 1
Specific Illustrations of Identifying Possible Inside Sources

| Client | Objective | Target Market | Possible Inside Sources |
|---|---|---|---|
| High-end | Attract stereo | Early adopters of | Tech bloggers, night club |
| Electronics Chain | equipment buyers | stereo equipment | owners, electronics repairmen, |
| | when new items are | | sales people at electronics |
| | first introduced | | retail stores (such as Best Buy) |
| New golf equipment | Build word-of- | Golfers | Caddies, pro shop staff, golf |
| company | mouth excitement | | instructors, groundskeepers, |
| | for new line of golf | | country club waiters, snack |
| | clubs | | shop vendors, event |
| | | | coordinators |
| Private client | Attract more high- | Fortune 500 | Chauffeurs, personal |
| investment service | worth clients | CEOs | assistants, charter flight pilots, |
| | | | Chief Operating Officers, |
| | | | tailors, accountants, attorneys, |
| | | | luxury car dealers |
| BBQ Sauce | Increase BBQ | People who like | Butchers, shelf stockers, |
| Manufacturer | sauce usage among | to barbeque | tailgaters, park managers |
| | light users | | |
| Arizona Spa | Reposition itself for | Affluent women | Jewelers, personal shoppers, |
| | elite Southern | | hairdressers, nannies, personal |
| | California market | | trainers |
| Restaurant in a | Increase visits to | Frequent travelers | Airport bartenders, flight |
| Famous Memphis | the restaurant by | to Memphis | attendants, airport security |
| Hotel | out-of-town | | staff, taxi drivers, hotel staff |
| | travelers on | | |
| | business accounts | | |

Types of Surveys.

Surveys of inside sources may focus on questions and projections. With questions, a researcher might ask an inside source about how a target market of consumers behaves. With projection, a researcher may ask an inside source to project why the targeted consumers behave in the way they do, or who they have the preferences they have. This third-party projection technique can tap into deeper insights from inside sources, since they have observed the behavior of many more people making similar decisions, including subtle insights that would not otherwise be detected by a consumer, himself. The objective of an interview with an inside source is to gain notable or unexpected key insights into the behavior of a target segment.

Reference is made to TABLE 2, with specific illustrations of projection insights from inside sources.

TABLE 2
Projection insights from inside sources

| | First | | Second Inside | |
|---|---|---|---|---|
| Client's Goal | Inside Source | Insights | Source | Insights |
| On-line cosmetics | Beauty | Customers like to test products before | Employee at | Customers are interested in alternative |
| company: | consultant | purchasing | store for | medicines and natural ingredients |
| Increase sales of | at cosmetics | Customers bring in magazine articles | spiritual | They like personal relationships with store |
| imported soaps | store | featuring products that interest them | and holistic | employees |
| | | Pre-teen and teen girls enjoy shopping in | health books | They like communal atmosphere of |
| | | groups | and supplies | shopping and appreciate recommendations |
| | | Many people buy online but return in store | | from fellow buyers |
| | | after they see and test product | | |
| Container and | Director of | Businesses often need product specifications | Waitress at | Customers who “doggie bag” food in |
| Storage Supply | Sales of metal | and dimensions. They want reliable and | restaurant that | aluminum containers often order larger, |
| Company: | distribution | consistent quality. | uses recyclable | more caloric dishes |
| Increase sales of | company | Businesses are already informed; they don't | aluminum | Food supply and storage needs vary month |
| recyclable | | need to be educated about the product. They | containers | to month depending on price changes and |
| aluminum | | buy only what they need, not what they | | diners' preferences |
| containers to | | want, whereas retail consumers buy what | | Most family-owned restaurants are looking |
| restaurants and food | | they want and not what they need. | | for a long term relationship with their |
| service companies | | Most business-to-business companies have a | | suppliers for better prices and customer |
| | | few key accounts, a small but loyal customer | | service |
| | | base. Face-to-face contact is valued highly. | | The recyclability of these containers is a |
| | | Distributers should develop partnerships | | major selling point and buyers like to see |
| | | with customers (e.g. purchase their stock | | companies that care about the environment |
| | | and offer on-site support if needed). This | | and sustainability |
| | | helps maintain business relationship in the | | When drinking a lot of soda, he doesn't |
| | | long-term | | always stick to a ‘favorite’ brand, just to add |
| | | The “stronger” or “sweeter” a soda tastes, | | variety |
| | | the better it masks the grease in the meal | | Variety in soda choice can add excitement to |
| | | | | an otherwise routine schedule |
| Manufacturer of | Pharmacist | Pharmacists approve of calcium | Registered | People who start taking supplements usually |
| chewable calcium | | supplements, but they don't make direct | dietician at | take them continually, becoming customers |
| supplements: | | recommendations to customers | assisted care | for life. |
| Market supplements | | More people take calcium for treatment than | facility | Many older users started taking them even |
| to women as means | | as a preventive measure | | before entering a medical facility or assisted |
| of preventing | | Purchasers of supplements tend to be well- | | care situation. |
| osteoporosis | | read, physically fit, pro-active and seek self- | | |
| | | improvement | | |
| | | People respond to fear tactics. | | |
| | | People like “combo items” that include | | |
| | | calcium and other vitamins | | |

Questions and Tactics.

To best capture useful insights in using interviews of inside sources, it is important to approach the interview as more of an engaging conversation, rather than as a checklist of questions. A conversation interview provides opportunities for the interviewee to fully explain the responses, beyond one-word answers or over-generalizations. To elicit insights from the interviewee, follow up questions employing laddering tactics may be used to uncover hidden layers of motivation and to probe deeper into surface explanations or answers.

Reference is made to TABLE 3, with sample follow-up questions and tactics to use in interviewing inside sources.

TABLE 3
Questions and tactics for interviewing inside sources

| When your Inside Source says . . . | It often means | Try responding like this . . . |
|---|---|---|
| “What's the point of all these questions?” | They are skeptical about the | “These questions help us understand (insert organization or company here) |
| “Who/What are you doing this for?” | purpose of the interview | and how they can improve their operations” |
| “Why are you asking me?” | | “We're looking for ways to increase sales/participation in (insert |
| | | organization or company here)” |
| | | “You're a knowledgeable source for (insert target segment here) since you |
| | | interact with these people often” |
| “I don't know” | They are thinking too | “Think of the last customer you had.” |
| “I never thought about it...” | generally and are not | “Who was your most memorable customer? What made them |
| “I can't think of anyone right now” | thinking about specific | memorable?” |
| “It's hard to say... everyone is different” | individuals or encounters | “What are some of the most popular or common items that were |
| | | selected?” |
| | | “If you were convincing a customer to come, what would you say?” |
| “It depends on the price” (or another | They are relying on an easy | “Let's think beyond the price, what would be the second biggest influence |
| response related to price) | answer without wanting to | on whether someone would purchase this?” |
| | dig any deeper | |
| “Rich people who like expensive things” | They are again thinking too | “Instead of thinking about these folks as a group, let's focus on individuals |
| “People like high-quality products” | general and not about | you've met. Try to picture a specific person who exhibited this |
| | exceptions to these basic | behavior.” |
| | rules | |
| “There's not one certain “group” or | They have difficulties | “What kinds of people do you see (insert a specific action or behavior |
| “category” that all our customers can be | thinking in terms of patterns | here)?” |
| placed in” | or sub-segments | “Can you recall any specific behaviors or unusual habits that your patrons |
| “All our customers are different and | | have?” |
| behave in different ways” | | “What other types of people might be interested in (insert topic here)?” |
| | | “Describe a prototypical customer. What is the typical profile of a loyal |
| | | customer?” |
| | | “What are some professions of your average customer?” |

Insights.

It is also important to translate insights obtained from inside sources into action. It is useful to organize these insights to fully integrate them into four key components of marketing—promotion, product, price, and place (the “4 Ps”) with the ultimate goal to suggest specific actions that will change behavior. In TABLE 4, insights obtained from TABLE 2 may be developed into specific marketing actions related to the 4 Ps.

TABLE 4
Specific actions from Table 2 insights

| Goal | Insights (from Table 2) | Promotion | Product | Place | Price |
|---|---|---|---|---|---|
| Increase | Purchasers are informed | Interactive website with | Welcome letter to first- | On-site recycling and | Offer payment |
| business-to- | about products they want | that tracks loyalty points | time customers | machinery that saves | extensions for |
| business sales | Appreciate reliability, | to use towards future | A clean, sleek company | energy and made of | companies that |
| of aluminum | consistency, and precise | purchases and allow | logo should be apparent | earth-friendly materials | struggle to pay on time |
| recyclable | product specifications | customers to construct | on all packaging to | promotes image of | Offer variety of |
| containers | Develop a few key | personalized purchase | promote brand | sustainability and saves | package options to suit |
| | accounts with close | and delivery packages | Include detailed product | money | product and delivery |
| | relationships and face-to- | Newsletter | specifications with each | Make meeting place for | needs of a variety of |
| | face contact | A loyalty program to | order | buyers a nice place so | customers |
| | Recognizable brand | track customers' good | Sales-people meet | they feel respected and | |
| | Focus on sustainability | behavior (e.g. on-time | buyers regularly to | comfortable; display | |
| | Buyers need flexibility as | payments, eco-friendly | maintain relationship; | quotes or statements that | |
| | purchase needs vary | business practices) | ask buyers if company's | promote trusting, caring, | |
| | according to customers | rewarded with coupons | products suit their needs; | long-term relationships | |
| | preference | or discounts on future | develop new products as | Set aside space in | |
| | | purchases | needed | production facility to | |
| | | A detailed product | | hold stock for customers | |
| | | specification booklet | | | |
| Encourage | Pharmacies don't often | Direct advertising | In developing other | Free samples by mail, in | Emphasize savings in |
| more | recommend these products | campaign at pharmacies | supplements in the | pharmacies or doctors' | time or convenience |
| people to take | to customers | Attempt to reach | future, companies should | offices | Chewable supplements |
| chewable | People respond well to fear | customers early in life so | include combinations to | Ask doctors to put in | can be taken at any |
| calcium | tactics and combination | they begin taking | vitamins and minerals to | bowls at reception desk | time without water and |
| supplements | items | supplements as a | encourage purchase | and in office waiting | are individually |
| | People who start taking | preventative measure | | room (like candy) | wrapped so may be |
| | supplements early are often | Use doctors and other | | | taken anywhere |
| | customers for life | health professionals as | | | |
| | Purchasers tend to be well- | authority figures in | | | |
| | read, physically fit, pro- | promotions | | | |
| | active and seek self- | | | | |
| | improvement | | | | |
| Increase | Customers like to test | Ask yoga and natural | Emphasize product | Send product samples or | Price may be raised |
| online | products before buying | beauty bloggers to | ingredients on website | scent samples by mail | because customers |
| sales of | Younger customers tend to | promote and link to | and how they aid in skin | Give samples to yoga | focus on ingredients |
| imported | shop in groups | company website | care | studios for bathroom use | rather than cost |
| soaps | Most buyers appreciate | Make website highly | | | |
| | recommendations from | interactive: create | | | |
| | fellow buyers | newsletter, blog or chat | | | |
| | Buyers like natural | forum | | | |
| | ingredients | Include feature on | | | |
| | Buyers refer to products | website for customers to | | | |
| | seen in magazines | recommend products to | | | |
| | | friends or write product | | | |
| | | reviews | | | |

Inside source interviews can impressively uncover unique insights that might otherwise be overlooked. The process usually involves choosing a research objective, selecting appropriate inside sources, determining specific questions that will elicit meaningful responses, and translating the responses into tangible actions within the marketing mix.

Insights from inside sources can be quantified by follow-up surveys and can be verified by experiments to improve marketing efforts. However, using inside sources has some limitations. Inside source responses can lack objectivity and may generate idiosyncratic insights that may be difficult to generalize. An advantage to the inside source approach is that it need not be limited to marketing. It can also be used to illuminate social concerns, such as healthy eating, active lifestyles and financial well-being.

Summarizing, inside source interviews concerned with the analysis of waste in cafeteria and restaurant food services might quickly and effectively provide unique and valuable insights that could be missed in costly laddering interviews, series of focus groups, and wide-scale surveys.

Behavioral Antecedents of Waste.

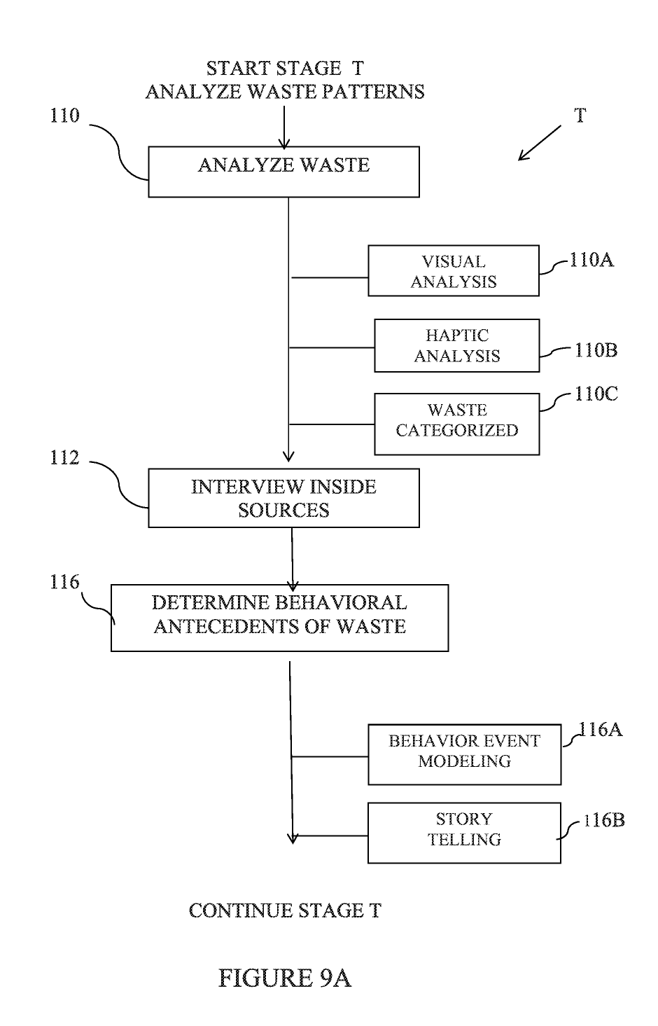

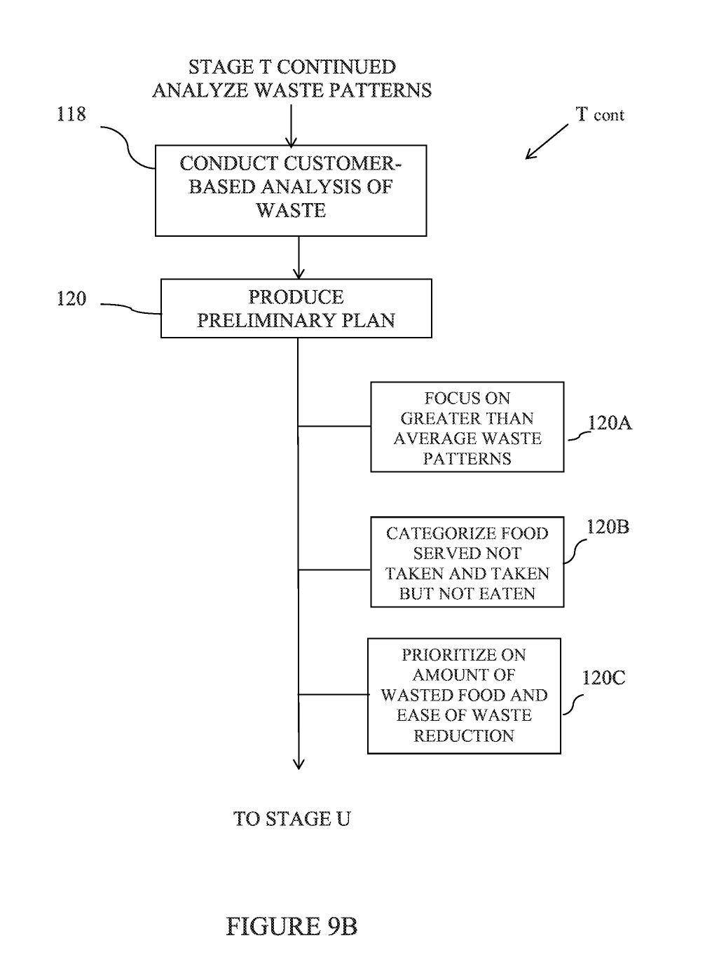

Referring again to FIG. 9A, in addition to interviews of inside sources at step 116, two processes for waste analysis are provided at step 5 to determine certain behavior antecedents of waste. At step 116A, behavioral event modeling is utilized, and at step 116B, a story telling method is used to determine antecedents of waste and possible solutions.

Behavior Event Modeling.

At step 116A, the main objective of behavior event modeling (“BEM”) is to determine possible sequences of events that would lead to a target outcome or “critical incident.” This approach critically identifies all of the various antecedent events that could possibly influence the target outcome or incident, as well as any indicators (signals) along the way. BEM constructs a predictive model of behavior by beginning with a critical event and then working backwards to identify different sequences of events that could lead up to the critical event, as well as the indicators that are associated with each event in a sequence. Accordingly, with BEM, the end outcome is the starting point rather than the final step. The advantage of this approach is that it allows for the development of a more diverse range of possible pathways that may lead up to a critical event, rather than having to begin the analysis with a given behavior having subsequent possibilities that may be more limited. Additionally, the BEM approach to predictive modeling is distinct in that it examines a sequence of events in its entirety and draws on past events as influencers of a specific behavior or critical incident.

BEM has advantages over conventional methods, such as focus groups or questionnaires. Consumers may not be able to determine or be able to articulate their subconscious decisions that may lead to a conclusion. Moreover, demographic and psychographic data can be extremely costly to obtain and may be skewed because of subjectivity. BEM is relatively quick and inexpensive and tends to be quite objective. It is also easily accessable, since all that is required is an imaginative mindset. It can also elicit insights without any other individuals actually present.

Thus, with BEM, one is concerned primarily with sequences of events leading to a critical incident, as well as indicators, insights and interventions that may arise.

BEM Example.

Looking at the BEM map below, a sample incident dealing with cafeteria or restaurant issues could be a critical incident encouraging changes in a restaurant. Various sequences of events are shown that could lead up to the critical incident, with arrows pointing towards the critical incident. Obvious indicators reflect events in the model that may or may not be seen, such as, “Store looks nice, decide to enter and look around.” Using BEM, one will also need to take into account the insights that develop as a result of numerous details, such as the types of individuals involved and the characteristics, motivations, and tendencies they may possess. In this example, a key insight might be, “A great deal of the café's success relies on impulse decisions.” There are also key interventions that have the potential to alter or interrupt the series of events or guide other behavior. In this example, an intervention might be, “Café needs to maintain its novelty and differentiate itself from other local eateries.”

TABLE 5
Behavior Event Modeling Map

| | | | | Interventions/ |
|---|---|---|---|---|
| | | | | Applications for |
| | | | | Marketing |
| Critical Incident | Possible events | Indicators | Insights | Mix (4 P's) |
| Purchase Food at Café | | | | |
| | | | A great deal of | |
| | | | Café's success | |
| | | | relies on impulse | |
| | | | decisions | |
| | Hear from friend that | Store looks nice, | | |
| | food is delicious | decide to enter and | | |
| | | look around | | |
| | | | Novelty is one of | Café needs to |
| | | | the café's greatest | maintain its novelty |
| | | | assets (for now) | and differentiate |
| | | | | itself from other local |
| | | | | eateries |
| | | | Business model of | Product: Being open |
| | | | Café is geared | 24 hours would add |
| | | | primarily towards | to its convenience |
| | | | customers coming | |
| | | | in to purchase food | |
| | | | and then promptly | |
| | | | leaving-as a stop- | |
| | | | and-go more so | |
| | | | than a target | |
| | | | destination | |
| | Reads article in daily | | | Promotion: |
| | local newspaper | | | generating publicity |
| | about newly opened | | | about the café |
| | café | | | through local |
| | | | | publications is an |
| | | | | excellent way for the |
| | | | | café to reach its |
| | | | | target market |
| | | | | Promotion: |
| | | | | sponsorship of |
| | | | | charity events in |
| | | | | conjunction with |
| | | | | local organizations |
| | | | | would encourage |
| | | | | more people to enter |
| | | | | and increase café |
| | | | | exposure |
| | Walks by café and | Decides to enter to | Café needs to be | Place: Since the café |
| | notice a sports game | watch the last few | able to attract | is located in a prime |
| | playing on their big | minutes of a football | people who are | location in the town, |
| | screen television | game | walking by to step | it should take |
| | | | inside | advantage of its |
| | | | | visibility |
| | | | | Make sure the Café |
| | | | | appears as inviting as |
| | | | | possible-have TVs |
| | | | | visible from the street |
| | | | | (to lure sports fans) |
| | | | | Promotion: Drink |
| | | | | specials on game |
| | | | | nights would also |
| | | | | encourage sports |
| | | | | lovers to enter the |
| | | | | café |
| | | | | Product: Food should |
| | | | | be readily visible; |
| | | | | displayed in buffet |
| | | | | style to entice visitors |
| | | | | Product: The café's |
| | | | | location is known for |
| | | | | its nightlife; adding a |
| | | | | bar area, karaoke, or |
| | | | | live DJ may |
| | | | | contribute to the |
| | | | | café's allure |
| | Decide to go out one | Food looks | Once inside, | Price: Charging for |
| | weekend | delicious/appetizing, | atmostphere | food from the buffet |
| | | decides to enter | should be | by the pound makes |
| | | | conducive to | customers less |
| | | | customers | cognizant of price; |
| | | | spending money | fosters greater |
| | | | | impulse buying |
| | | | | decisions |
| | | | Café's appeal is | |
| | | | also a result of its | |
| | | | convenience- | |
| | | | restaurant needs to | |
| | | | make itself as | |
| | | | convenient as | |
| | | | possible for its | |
| | | | target market | |
| | Running late to work | | | Product: providing |
| | and in a rush, forgets | | | pre-packaged and |
| | lunch at home | | | pre-prepared foods |
| | | | | with easy access for |
| | | | | those in a rush |
| | Joins a local | Organization hosts a | | |
| | organization | charity event at café | | |

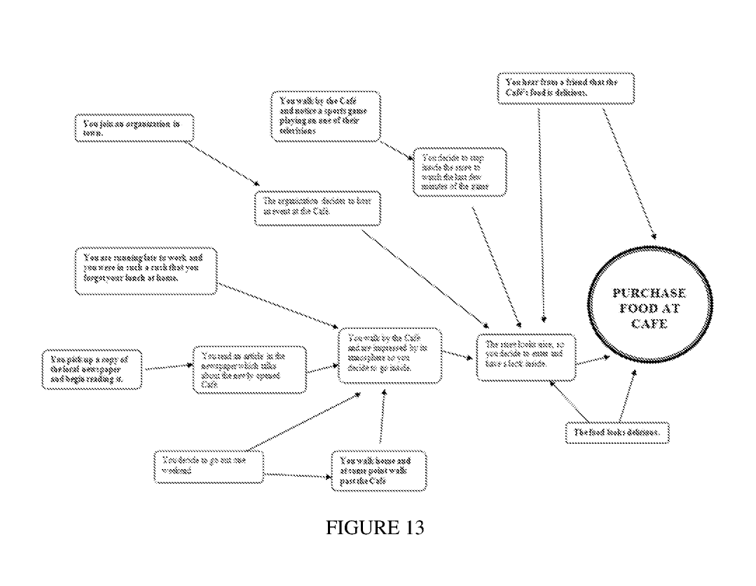

TABLE 5 corresponds to the behavior event modeling map shown in FIG. 13, which identifies a variety of possible events and/or other factors that might lead an individual to eat food from a particular café. In addition to the events shown in FIG. 13, TABLE 5 identifies possible insights and interventions (e.g., promotions, locations, products, prices, etc.) that might contribute to the desirability of the café to potential customers.

Story Telling Method.

In addition to the foregoing, a story-telling process may be used to determine the reasons consumers engage in low-consciousness decision making, which is done almost automatically. In the story-telling method of insight generation, researchers use direct behavior observations of a consumer to stimulate insights on motivations for their actions and on influential variables in their environment. The story-telling method is important in identifying the reasons for low-involvement behavior which become the subconscious rationale behind consumer decision making. It is a low-cost, simple way to develop insights that may lead to changes in an establishment. By telling the story about another person, a researcher is freed from inhibitory reactions during observational situations.

In the story-telling method, researchers generate insights rooted in observation of actions. The researcher usually sets the scene for a consumer with a general description of the appearance and socioeconomic status of a hypothetical individual, and a narrative describing objective events and behavior that has occurred with the individual. With this background, a consumer is requested to tell a story about how the individual reacts to his surroundings and activities, and describe actions that the individual is likely to take. A researcher might start the story-telling by asking why the individual took the action described or found himself in the event described. The individual will then make inferences about the situation to carry the story forward. Each step of imagined inferences builds upon the previous one, all rooted in each initial observed action.

Example of Story-Telling Method.

Referring to TABLE 6 below, the story-telling method is used to generate insights about how a fast food restaurant could improve its services. A researcher observes an overweight woman sitting with a companion in a fast food restaurant. She appears to be in her mid to late 20's and lower middle class, and she has slightly disheveled clothing with hair in an un-styled pony tail and without makeup. She is slumped over and is inattentive to her companion.

The researcher may make up a plausible story, based on these initial observations. For example, she may have awakened late at her boyfriend's house, the companion she is with. She did not want to cook a meal so they went to the restaurant for lunch because it is cheap and they have a limited budget for dining out.

TABLE 6
Story telling example regarding fast food restaurant
Using Storytelling Method to Generate Insights about How a Fast Food Restaurant
Could Improve Its Service
Appearance:
Overweight woman, mid to late 20's. Slightly disheveled clothing with hair put into a ponytail,
unstyled. No makeup worn. Not destitute, but probably lower middle class. Sitting slumped over and
seems inattentive to her companion.
Background story of the day:
Woke up late at her boyfriend's house, the companion she is with. Did not want to cook a meal, so
they chose McDonald's for lunch because it's cheap and they have a limited budget to spend on dining
out.

| Observation | Inference | Testable hypothesis |
|---|---|---|
| Clothes are ill-fitting and worn | Low income | Low income correlates with lower food |
| out, shoes are worn and dirty | | availability, influencing food and restaurant |
| | | choice. |
| | | When a person is insecure about where the |
| | | next meal will come from, they are more |
| | | likely to clean their plate. |
| Hair thrown into a messy pony- | Why did she fail to dress up? | Messiness is an indicator of low |
| tail, not blown dry, wearing | Not trying to seem fashionable, OR | expectations for a given experience. |
| out of fashion hair accessory | Don't need to impress at | |
| | McDonalds. | |
| Wipes hands on pants leg to | Why did she not use a napkin? | People who don't perceive a situation as |
| clean it off | Environmental cue: McDonald's is | refined or sophisticated will feel less |
| | not particularly clean, doesn't | inclination towards image management. |
| | inspire one to uphold a standard of | Napkin disuse is correlated with lower |
| | cleanliness while dining there. | dining expectations. |
| Dips each bite of every food | Why did she dip every food in | Repeated behaviors may indicate |
| (chicken sandwich, French fries, | honey mustard and not only the | familiarity with a given location. |
| and nuggets) in honey mustard | fries? | Familiar locations may instigate ritualized |
| sauce before eating it | Environmental cue: At | behaviors. |
| | McDonald's, the honey mustard | |
| | stimulates this behavior. | |
| | May not dip every food at every | |
| | meal in honey mustard unless at | |
| | McDonald's. | |
| Sitting slumped over, not | Why is she not conversing with her | When engaging in conversation with a |
| talking to companion | dining companion? | longtime companion, less likely to be |
| | Her companion isn't someone | conscious of your self-presentation. |
| | she's trying to impress. | |
| | This is not the first time she has | |
| | come to a McDonald's, so nothing | |
| | new to notice about dining there. | |
| Eats each bite in rapid suc- | Why does she not eat at a slower | Lights, music, and colors may substantially |
| cession, never pauses between | pace? | influence rate of food consumption. |
| bites, and does not chew. | Environmental cue: The bright | |
| | yellow and red color scheme, fast | |
| | music, bright lighting at | |
| | McDonalds may have stimulated | |
| | faster eating. | |
| Eats French fries before trying | Why didn't she taste some of her | For people who eat the most 'indulgent' |
| any other food | other, more healthful food first? | food first and fill up at the expense of |
| | Habitual decision; she always eats | more healthful foods, it follows that |
| | the French fries in that order. | nutrition is not a priority. |
| | | People entrenched in routine are less |
| | | attentive to hunger and fullness cutes. |
| Finishes all of the food on her | Why did she not leave food on her | People who engage in habitual, non-hunger |
| plate | plate? Because it is habit to clean | based eating patterns are more likely to |
| | the plate. | clean their plate, regardless of portion |
| | Environmental cue: eat until the | size. |
| | food is gone, not until her hunger | |
| | is gone influenced this behavior. | |

As the researcher watches, he draws inferences from her actions and develops testable hypotheses about her and about people like her. These hypotheses may then be applied to a fast food restaurant setting to tailor the environment that would encourage desirable actions and discourage undesirable actions. A targeted advertising campaign might be developed to focus on expectations of customers may who have certain preferences. A hypothesis of customers having low expectations may lead a cafeteria to focus on habitual eating patterns rather than hunger and fullness cues. A dietician might identify drivers of mindless eating to facilitate restructure of less healthful eating patterns.

Customer Analysis of Waste and Satisfaction.

At 118 in FIG. 9B, customer analysis of waste and customer satisfaction is included. Data regarding self-reported descriptions of waste may be computer processed to assist in analyzing waste patterns. Customer analysis of waste and satisfaction may both be determined through insights obtained through story-telling. Incidents influencing satisfaction and dissatisfaction may be assessed through in-person interviews and open-ended surveys. Satisfaction is likely to also be determined by the perceived purposes of the eating establishment. For example, a restaurant in a business-related hotel is likely to have a main purpose of providing quality food with little concern about flair. In contrast, a restaurant located in a tourist-related hotel is likely to focus on providing an adventure along with exciting foods.

Preliminary Plan for Waste Reduction.

At 120 in FIG. 9B, a preliminary plan is developed for waste reduction. The first step focuses on how preparation waste can be reduced by better managing and predicting customer demand. The second step focuses on how plate waste can be reduced by altering traffic patterns, food layout, portion sizing, selection norms, serving quantities, taste expectations, and the like.

In step 120A, the focus is on those areas (such as hot foods, meats, salads, breads, desserts, and so forth) where the waste patterns may be higher than a targeted threshold (e.g., greater than average) for a cafeteria in its particular industry. Having identified the specific target categories that may be most problematic in step 102 and understanding initial possible reasons for the waste determined in step 110, the general categories of food may be prioritized at step 120B for action based on whether the problem comes from (i) whether the food is served but not taken or (ii) whether it is taken but not eaten.

For each of these two categories, food items may be then prioritized based on (a) amount of wasted food (in dollars) and (b) ease of waste reduction. High cost foods which can be easily reduced or eliminated to reduce or minimize waste will be prioritized for action over lower cost foods which may be more difficult to reduce or eliminate from the menu. The actual solutions for reducing the prioritized foods will be determined by combining insights from inside source interviews (Step 112), insights from Behavioral Event Modeling and the Storytelling Method (Step 116) and customer process interviews (Step 118).

The resulting plan provides a set of actions which may be taken to partially remedy or reduce the problem with food waste and food costs within each category of food. What is important to understand, however, is that efforts at reducing food costs by reducing food waste can also reduce a diner's satisfaction toward a cafeteria or a restaurant. For instance, in an extreme case, having only a few food items in a small quantity would succeed in greatly reducing food costs, but it would also greatly reduce satisfaction because a person would not have a wide range of foods to sample and they would not have enough food to be full. Accordingly, the objective is to reduce food waste and food costs in a way that does not hurt a diner's satisfaction.

Stage U—Satisfaction Analysis

Before final recommendations may be provided it is important to determine what foods can be eliminated from the cafeteria and which new foods, if any, should be introduced. Both of these may be driven by customer satisfaction. If customer satisfaction is a critical issue, it should be considered as the second phase of a cafeteria makeover.

Laddering Analysis of Cafeteria Champions.

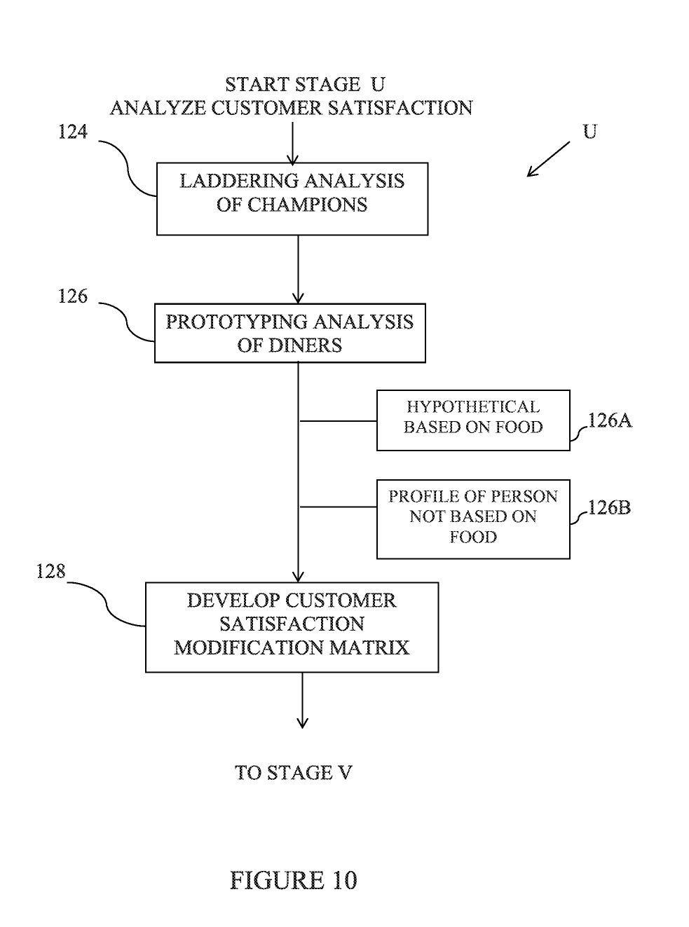

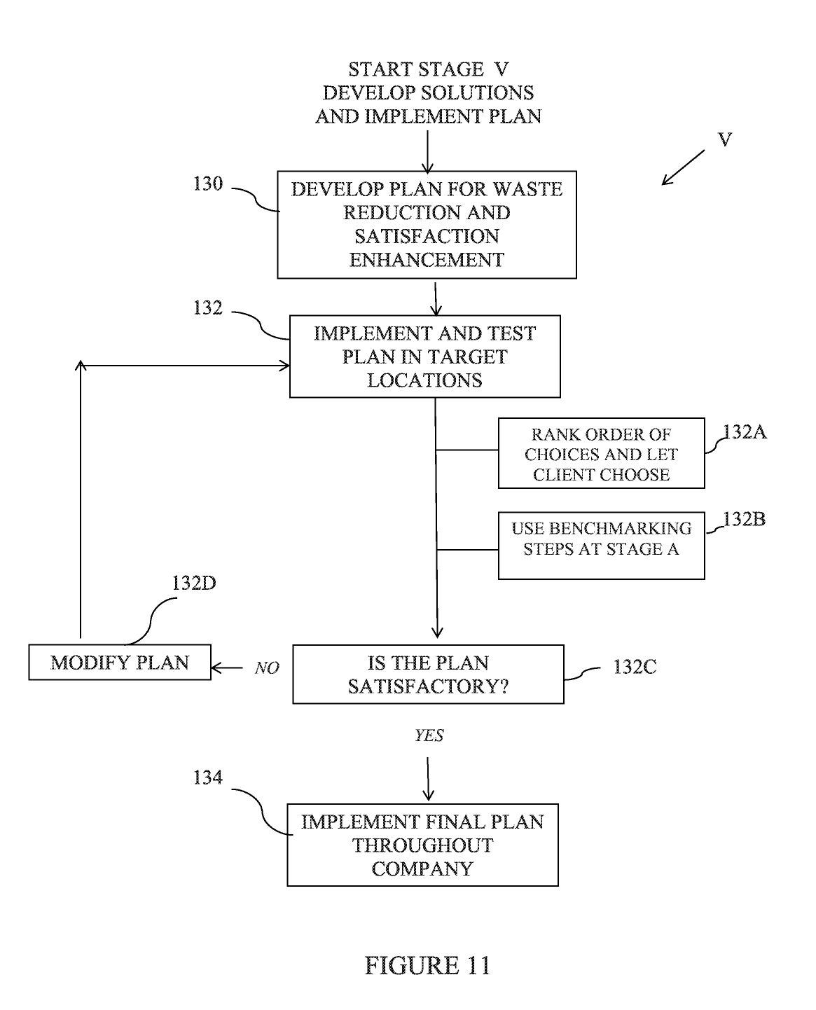

Looking now at step 124 in FIG. 10, a new laddering analysis is made, focusing on cafeteria and restaurant champions. By identifying the most satisfied customers, laddering interviews may be conducted to determine the attributes they initially identify as sources of their heightened satisfaction, the resulting consequences of this satisfaction, and the higher related values. In known techniques of laddering interviews follow-up questions are asked to uncover deeper motivations for the values of the customer.

Analysis of Champions.

In this new approach, only major champions of a cafeteria or restaurant are chosen for interviews. These are customers who are enthusiastic, even fanatical, about the eating establishment, and would go out of his way to be able to return to it again and again. These champions may be asked several questions that all focus on the reasons that they are so enthusiastic about the eating place.

The interviews may be conducted in person, by phone, or through the use of cards or surveys, although face-to-face interviews are preferred—in person, or via SKYPE® or phone.

Prototyping Analysis of Diners.

Diners may be prototyped based on how likely they are to be wasteful and dissatisfied. Known prototype analysis is used to create different solutions for three of the most critical segments of diners, using a prototyping methodology explained in Wansink, Brian, “The Customer Prototyping Technique: Its validation and Application,” Journal of Targeting, Measurement and Analysis for Marketing, p. 18 (Jul. 8, 1994), incorporated in full herein.

Mentally visualizing a prototypical member of a market segment is critically important. Customer prototyping may be done through laddering questions and procedures to describe a very specific hypothetical member of a target sub-segment of the marketplace. The assumption is that the insights obtained from describing and analyzing this particular individual may frequently be generalized across a broader segment. It is quick, inexpensive and easily interpretable.

A new prototyping process may be used, in which all questions have to do with a profile of a person, rather than focusing on a specific aspect, such as food. By outlining a complete profile of a customer, solutions are more easily understood regarding the necessary features and aspects of an eating establishment under consideration.

Develop a Customer Satisfaction Modification Matrix.

Referring again to FIG. 10, based on the results of laddering interviews and prototypes of key customer prototypes, three sets of recommendations for food item eliminations, additions, and physical modifications to the cafeteria (including layout, messaging, and so forth) will be presented for each of the three segments. These recommendations may be based on the results of Steps 110 through 120 in Section T regarding waste analysis and reduction. A new customer satisfaction modification matrix is developed in quadrants showing how each of the potential recommendations the changes will influence be received by each of the three customer prototypes that may be most relevant to the success of the business. This quadrant matrix may take an initial form that is focused on features that vary in importance to customers versus features that vary in cost savings for a given amount of waste. Reference is made to TABLE 7 showing a sample quadrant matrix.

Stage V—Developing Solutions, Testing and Final Plan

Developing a Plan for Waste Reduction and Satisfaction Enhancement.

Looking now at FIG. 5, the preliminary waste reduction plan is integrated with the Customer Satisfaction Modification Matrix to determine the priorities for change, based on what will reduce waste (food costs) and increase key satisfaction ratings for the least cost for the most important target segments.

In Steps 30-38, the range of possible waste recommendations was determined to reduce the biggest potential waste problems. These may be crossed with the three primary prototypes of consumers to determine which of these recommendations has the least negative impact on these segments individually and in the aggregate. This result provides the priority recommendations that may be proposed. One approach is to first rank an order of choices that may be desirable using key factors, such as cost savings and best improvement in satisfaction. Then a client would select the changes to implement.

Implementing and Testing the Proposed Plan in Initial Target Locations.

As shown in FIG. 5, the agreed upon plan is implemented for an agreed upon time period. The same measures of waste and satisfaction that were collected at the beginning of the project in benchmarking steps 20 and 22 may be now collected at this point and analyzed.

Present Implementation Plan.

Based on modifications following the testing period one or more plans may be presented to management based on any variations between types of units, such as small versus large.

Stage W—Implementation Oversight and Cost/Satisfaction Monitoring

Oversee the Revised Implementation Plan.

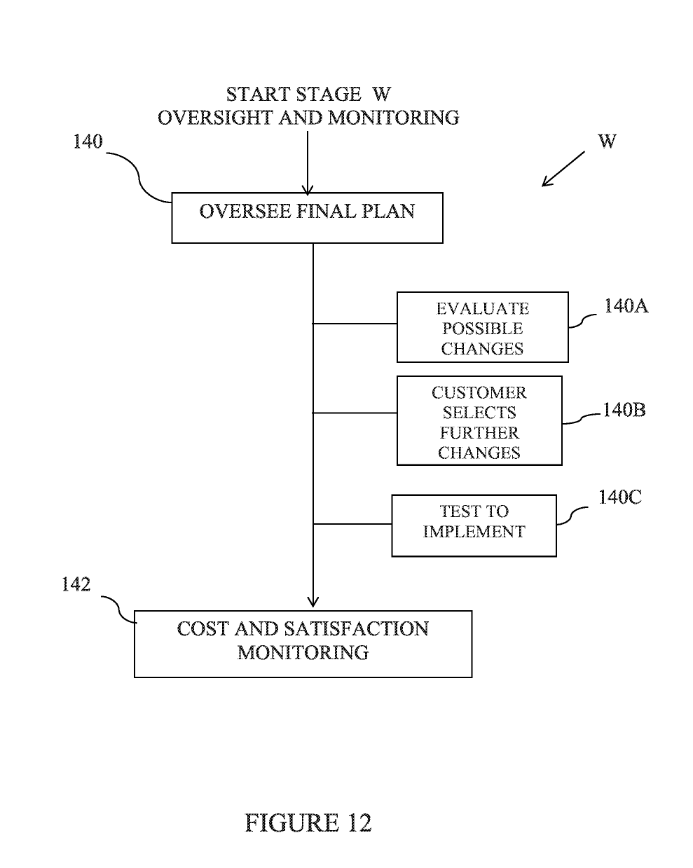

Referring now to FIG. 12, upon acceptance of the final plan, a separate engagement involves implementation across units. One key part of this implementation is the development of basic scorecards that enable operators of different units to determine what is most feasible for them. The development of these scorecards incorporates the actions identified in Steps 30-38. These scorecards consist of binary “yes/no” questions which enable an operator or an evaluator to determine how compliant a particular cafeteria is regarding making the changes that may be most associated with reduced food waste.

Consider a scorecard of 25 actions that were initially identified in Steps 30-38 and which was subsequently screened down to 17 actions in Step 128. This list of 17 actions (such as “desserts may be offered in ½ size portions”) can be answered by a layperson based on yes/no answers. A score of 17, in this example, would be a perfect score. See TABLE 8 for a sample scorecard that could be used in this example.

TABLE 8
Sample 100 point scorecard for restaurants
Slim by Design Restaurant Self-Assessment Scorecard
Is your favorite restaurant making you slimmer or fatter? This scorecard will tell you. The higher the
score, the harder they're trying to make you slim. Anything that isn't checked is one more change they
can make. Pick out something they could do to make you eat a little better and to be a happier customer.
Then ask them to help. These are all proven, research-based (or at least principle-based) changes that
help people eat less and help restaurants make money. We update them each year with our newest
findings-check them out again next year with the newest scorecard at SlimByDesign.org.

PRE-MEAL AND DÉCOR
The restaurant lighting is neither too bright nor too dark
At least some dining locations are well lit
The restaurant is neither too loud nor too quiet
At least some dining locations are quiet
There are scales in the bathrooms
Customers are seated near the windows first; dark corners last
There no more than two TV sets (including in the bar area)
There are no TV sets (including in the bar)
Bread (including tortillas) is brought only upon request
Water glasses are at each table setting (along with utensils) when diners are seated
Water is provided to everyone, or each is asked if they want water
Water glasses hold at least 12 ounces
Raw vegetables or a healthy sample (amuse-bouche) are offered before dinner instead of bread
MENU DESIGN
At least 3 healthy appetizers are offered
At least 3 healthy entrées are offered
At least 3 healthy desserts are offered
At least 3 healthy beverages (other than water) are offered
A nonstarch vegetable or fruit is the default
A salad is the default
A soup option is available as a substitute
Include a healthy side with unhealthy entrées
Colored or bolded words are used to highlight healthy target foods
Logos or icons are used to draw attention to targeted items (but don't use “healthy” logos, which can
signal bad taste and scare diners away)
There is a healthy section of the menu labeled “Light and Fresh” or a similar taste-related phrase
Selected entrées are available in half-size portions (but labeled as trim, moderate, light, and so on)
Appealing and evocative words are used to describe healthy items to make them sound mouthwatering
At least 5 healthy items are placed in one of the four corners or special sections of the menu
Salads are the default side dish selection for lunch (as opposed to French fries)
The healthier items are listed first in each of the menu sections (such as appetizers, entrées, desserts,
and so on)
Healthy, high-margin items are in bold or in colored boxes to call them out (when appropriate)
Waitstaff is instructed to recommend healthy pairings
Appealing photos of healthy target items are highlighted on the menu or table tents (when appropriate)
Calorie levels of selected items are on the menu or available
A separate menu or an app with calorie listings is available
KIDS' MEALS
The kids menu offers fun, healthy options (such as Broccoli Madness)
The healthier items on children's menus are bright and appealing
Coloring books or interactive placemats are related to nutrition
Friendly cartoons promote healthy foods on the kids menus
Fruit or vegetables are the default side item
Nonfat or 1 percent milk is the default beverage
Plates, glasses, and bowls are smaller for children than adults
WAIT STAFF
Mentions at least one special of the day that is healthy
Mentions that to-go boxes are available before people order
Mentions a “we'll pack half” policy before serving
Mentions the healthiest side items first
Mentions healthy substitutes
Offers desserts to go
Mentions to-go containers for desserts
Mentions healthy desserts first
Knows the two or three lighter entrées that get the most compliments
SPECIALS AND PROMOTIONS
At least 1 appetizer special is healthier
At least 1 entrée special is healthier
At least 1 dessert special is healthier
Display and dramatize healthy options as the first thing seen when entering and as point-of-purchase
display, visible and accessible (for example, a salad bar by the counter, apples by the register)
Half of any coupons offered promote healthier items
Half the items promoted on the website are healthier items
A frequent salad-buyer program is available (such as 5 salad punches = free salad)
Family combos are served-kid's dish with an adult dish, or family-style dishes that can be split
Discounts or deals are available on healthy family meals
Meal bundles or combos are available that feature healthy combinations and nonfried food, and veggies
with an appetizer, salad, and small dessert
The first specials mentioned are ones that offer salad as a course
Delivery or carry-out meals contain a fruit or healthier salad option
Meals are lower in calories than the dine-in equivalent
A gym, fitness, or health center is co-promoted in the restaurant
A discount on healthy meals is offered on a predetermined sponsor night-where the restaurant
donates the savings to the targeted charity or cause.
DINNERWARE
Plates are less than 10 inches in diameter
Plates are a darker color than white or beige
Bowls hold 16 ounces or less
Bar glasses are tall and narrow
Wineglasses are narrower at the bottom than the top
Plates have a wide colored rim
PORTION SIZE, PREPARATION, AND SUBSTITUTION OPTIONS
A double portion of vegetables is available for a side dish substitution
The entrée special is available in a half-size portion
At least 3 entrées are available in half-size portions
The dessert special is also available in a half-size portion
At least three desserts are available in half-size portions
Vegetable portions are 20 percent larger than in the past
The size of vegetables on the plate has increased and the size of the starch has decreased
There is the option of having your food cooked with a low-fat spray (like Pam)
You have the option of requesting the type of cooking material you would like used (for example,
cooking pasta with water instead of oil)
There is the option of having either lightly or regularly seasoned versions
Dressings and sauces can be requested on the side (when appropriate)
Extra vegetables can be substituted for the starch
Soup can be substituted for the starch
Salad can be substituted for the starch
Fruit or a fruit salad is available instead of traditional desserts
Sugar-free syrup is available
Sugar-free jellies are available
BAR
Default glasses are tall and narrow (rather than short and wide)
Wineglasses are narrower at the bottom than at the top
Patrons are asked if they would like a glass of water
Wine flights (small 2-ounce samples) are available
Diet tonic water is available
Nonalcoholic beer is available
There is a wine special
Bar snacks are provided only when requested
Bar snacks are healthier, such as nuts rather than chips and Chex Mix
SCORING BRACKETS
70-100-Slim by Design Restaurant-Gold
50-69-Slim by Design Restaurant-Silver
30-49-Slim by Design Restaurant-Bronze

By periodically using scorecards to evaluate a cafeteria or restaurant, one can monitor whether the recommended actions may be part of the routine, and can identify which actions need to be taken again. Additionally, for a cafeteria that has multiple units, such as a chain, scorecards allows one to compare different units with each other to determine which ones may be most compliant and adherent to making these recommended changes.

Cost/Satisfaction Monitoring.

Referring to 142, by cross analyzing subsequent re-measurements of cost and satisfaction with implementation scorecards, adjustments may be made to determine which changes result in the greatest waste reduction in the field and which result in the greatest customer satisfaction. Adjustments can be made on a periodic basis (such as semi-annually or annually).

Although the foregoing description contains many specifics, these should not be construed as limiting the scopes of the inventions recited by any of the appended claims, but merely as providing information pertinent to some specific embodiments that may fall within the scopes of the appended claims. Features from different embodiments may be employed in combination. In addition, other embodiments may also lie within the scopes of the appended claims. All additions to, deletions from and modifications of the disclosed subject matter that fall within the scopes of the claims may be to be embraced by the claims.

What is claimed:

1. An eating establishment designed to reduce waste and increase customer satisfaction, comprising:
a waste standards section that develops waste standards for determining food waste,
a satisfaction standards section that develops satisfaction standards for determining customer satisfaction,
a waste pattern analysis section that analyzes waste patterns based on compliance by the eating establishment with the waste standards, and
a customer satisfaction analysis section that analyzes customer satisfaction based on compliance by the eating establishment with the satisfaction standards.

2. The eating establishment of claim 1 wherein the waste standards section comprises a first sensing unit that determines average food waste of the eating establishment and/or other comparable eating establishments by sensing weight, size, feel and/or the appearance of the food waste over a period of time.

3. The eating establishment of claim 1 wherein the satisfaction standards section comprises a survey unit that conducts one or more customer surveys customer recommendations, value of the eating establishment to the customer, and/or repeat patronage by the customer.

4. The eating establishment of claim 1 wherein the waste pattern analysis section that analyzes waste patterns comprises a second sensing unit that determines current food waste of the eating establishment by sensing weight, size and/or the appearance of the food waste of the eating establishment.

5. The eating establishment of claim 4 wherein the waste pattern analysis section further comprises a category sensing unit to categorize factors related to reducing waste by determining waste by degree of overall cost of the waste, and/or by degree of ease of reducing waste.

6. The eating establishment of claim 4 wherein the waste pattern analysis section further comprises an interview unit that conducts interviews of inside sources and customers and determines waste by behavioral antecedents of waste and/or by customer analysis.

7. The eating establishment of claim 1 wherein the waste pattern analysis section comprises a planning unit that produces a preliminary plan by determining greater than average food waste patterns, categories of food served, food not taken and/or food not consumed.

8. The eating establishment of claim 1 wherein the customer satisfaction analysis section comprises a laddering unit that applies laddering methods with champions of the eating establishment.

9. The eating establishment of claim 1 wherein the customer satisfaction analysis section comprises a prototype analysis of diners unit that determines prototyping methods of customers based on food and/or factors other than food.

10. The eating establishment of claim 1 wherein the customer satisfaction analysis section comprises a matrix unit that develops a customer satisfaction matrix that focuses on customer satisfaction and/or food waste and cost savings.

11. A method for an eating establishment to reduce waste and increase satisfaction, comprising:
establishing waste standards for determining food waste,
establishing satisfaction standards for determining customer satisfaction,
analyzing waste patterns based on compliance by the eating establishment of the waste standards, and
analyzing customer satisfaction based on compliance by the eating establishment of the satisfaction standards.

12. The method of claim 11 wherein establishing waste standards comprises determining average food waste of the eating establishment and/or other comparable eating establishments by sensing weight, size, feel and/or the appearance of the food waste over a period of time.

13. The method of claim 11 wherein establishing satisfaction standards comprises conducting one or more customer surveys regarding customer recommendations, value of the eating establishment to the customer, and/or repeat patronage by the customer.

14. The method of claim 11 wherein waste pattern analysis comprises determining current food waste of the eating establishment by sensing weight, size and/or the appearance of the food waste of the eating establishment.

15. The method of claim 14 wherein waste pattern analysis further comprises determining waste by degree of overall cost of the waste, and/or by degree of ease of reducing waste.

16. The method of claim 14 wherein waste pattern analysis further comprises an conducting interviews of inside sources and customers and determining waste by behavioral antecedents of waste and/or by customer analysis.

17. The method of claim 11 wherein waste pattern analysis comprises producing a preliminary plan by determining greater than average food waste patterns, categories of food served, food not taken and/or food not consumed.

18. The method of claim 11 wherein customer satisfaction analysis comprises applying laddering methods with champions of the eating establishment.

19. The method of claim 11 wherein customer satisfaction analysis comprises determining prototyping methods of customers based on food and/or factors other than food.

20. The method of claim 11 wherein customer satisfaction analysis comprises developing a customer satisfaction matrix that focuses on customer satisfaction and/or food waste and cost savings.

21. The method of claim 11 and further comprising developing an initial plan with various solutions ranking choices based on factors of satisfaction, waste and cost.

22. The method of claim 21 and further comprising utilizing the process of claim 11 to obtain feedback regarding the viability of the initial plan.

23. The method of claim 22 wherein the feedback is obtained by using scorecards to evaluate the initial plan.

24. The method of claim 22 wherein the feedback is used to modify the initial plan to obtain a revised plan which is implemented in the eating establishment.
